(19) United States
(12) Patent Application Publication
(10) Pub. No.: US 2026/0061455 A1
(43) Pub. Date: Mar. 5, 2026

(54) FLUENT MATERIAL DISPENSING SYSTEM AND A DISPENSING MECHANISM THEREFOR

(71) Applicant: Franke Kindred Canada Limited, Midland (CA)

(72) Inventors: Adrian FISHER, Vancouver (CA); Dominic WONG, Langley (CA)

(73) Assignee: Franke Kindred Canada Limited, Midland (CA)

(21) Appl. No.: 19/207,026

(22) Filed: May 13, 2025

Related U.S. Application Data
(60) Provisional application No. 63/688,733, filed on Aug. 29, 2024.

(51) Int. Cl. B05C 17/01; B05C 17/005

(52) U.S. Cl. CPC B05C 17/0123; B05C 17/00576

(57) ABSTRACT

There is provided a dispensing mechanism for a bottle or cartridge. The mechanism includes a lever actuation of which causes a plunger to slidably engage an inner sidewall of the bottle and travel in a first direction towards an outlet of the bottle to expulse fluent material therefrom. The mechanism includes a portion stop connected to a cap and positioned at a defined location along the path of travel of the lever. The distance traveled by the lever is limited by direct contact of a tooth of the lever with the portion stop, thereby limiting the distance traveled by the plunger to limit an expelled amount of the fluent material to a corresponding defined portion. The tooth, when actuated, subjects the portion stop to a load. The tooth is shaped to promote spreading out of the load so as to inhibit damage/wear to and/or deformation of the cap.

### BACKGROUND OF THE INVENTION

### Field of the Invention

There is provided a dispensing system. In particular, there is provided a fluent material dispensing system, and a dispensing mechanism therefor.

### Description of the Related Art

U.S. Pat. No. 8,511,520 to van Wijke et al. discloses a fluent material dispensing system. The system includes a bottle. The system includes a plunger engaged inside the bottle. The system includes a dispensing mechanism having a lever for operation of the plunger for fluid expulsion. The plunger may frictionally engage the bottle to a degree sufficient for holding the plunger in place against a force applied due to return motion of the lever. The dispensing mechanism may include a cap for attachment to an end of the bottle opposite a fluid outlet. The dispensing mechanism may include a handle attached to the cap. The lever pivotally couples to the cap. The lever and handle align with the bottle. The dispensing mechanism may comprise a portioning mechanism configured to limit distance traveled by the lever from the rest position to the engaged position to a defined amount, thereby limiting expulsion of the fluid to a corresponding defined portion.

The above-described prior art may suffer a number of disadvantages.

### BRIEF SUMMARY OF INVENTION

There is provided, and it is an object to provide, an improved fluent material dispensing system disclosed herein.

There is accordingly provided according to one aspect a dispensing mechanism for a bottle or cartridge. The dispensing mechanism includes a lever actuation of which causes a plunger to slidably engage an inner sidewall of the bottle and travel in a first direction towards an outlet of the bottle to expulse fluent material therefrom. The dispensing mechanism includes a portion stop connected to a cap and positioned at a defined location along the path of travel of the lever. The distance traveled by the lever is limited by direct contact of a tooth of the lever with the portion stop, thereby limiting the distance traveled by the plunger to limit an expelled amount of the fluent material to a corresponding defined portion. The tooth, when actuated, subjects the portion stop to a load. The tooth is shaped to promote spreading out of the load so as to inhibit damage/wear to and/or deformation of the cap.

There is further provided according to an additional aspect a dispensing mechanism for a bottle or cartridge configured to hold a fluent material. The dispensing mechanism includes a lever actuation of which causes a plunger to slidably engage an inner sidewall of the bottle and travel in a first direction towards an outlet of the bottle to expulse the fluent material therefrom. The lever includes a tooth protruding outwards a defined distance along a path of travel of the lever. The tooth includes a first end portion adjacent a first side of the lever and a second end portion adjacent a second side of the lever. The dispensing mechanism includes a portion stop at a defined location along the path of travel of the lever. The distance traveled by the lever is limited by direct contact of the tooth with the portion stop located within the path of travel, thereby limiting the distance traveled by the plunger to limit an expelled amount of the fluent material to a corresponding defined portion.

There is also provided according to another aspect a dispensing mechanism for a bottle or cartridge configured to hold a fluent material. The dispensing mechanism includes a cap for attachment to an end of the bottle. The dispensing mechanism includes a lever pivotally coupled to the cap via a metal bearing pin. Actuation of the lever causes a plunger to slidably engage an inner sidewall of the bottle and travel towards an outlet of the bottle to expulse the fluent material therefrom. The dispensing mechanism includes a portion stop at a defined location along the path of travel of the lever. The distance traveled by the lever is limited by contact of the lever with the portion stop located within the path of travel, thereby limiting the distance traveled by the plunger to limit an expelled amount of the fluent material to a corresponding defined portion.

There is further provided according to an additional aspect a dispensing mechanism for a bottle or cartridge configured to hold a fluent material. The dispensing mechanism includes a cap for attachment to an end of the bottle. The dispensing mechanism includes a lever pivotally coupled to the cap via a metal member. The metal member may comprise a sex bolt, a fastener and a barrel nut shaped to threadably coupled with the fastener, a spring, a cotter pin, a clevis pin, or a set of spring loaded plungers, for example. Actuation of the lever causes a plunger to slidably engage an inner sidewall of the bottle and travel towards an outlet of the bottle to expulse the fluent material therefrom. The dispensing mechanism includes a portion stop at a defined location along the path of travel of the lever. The distance traveled by the lever is limited by contact of the lever with the portion stop located within the path of travel, thereby limiting the distance traveled by the plunger to limit an expelled amount of the fluent material to a corresponding defined portion.

There is yet also provided according to a further aspect a dispensing mechanism for a bottle or cartridge configured to hold a fluent material. The dispensing mechanism includes a lever. Actuation of the lever causes a plunger to slidably engage an inner sidewall of the bottle and travel in a first direction towards an outlet of the bottle to expulse the fluent material therefrom. The dispensing mechanism includes a portion stop at a defined location along the path of travel of the lever. The distance traveled by the lever is limited by contact of the lever with the portion stop located within the path of travel, thereby limiting the distance traveled by the plunger to limit an expelled amount of the fluent material to a corresponding defined portion. The dispensing mechanism includes a handle aligning with said first direction. The lever pivotally couples to and is received at least in part within the handle. The lever and the handle are shaped to facilitate cleaning thereof without requiring disassembling thereof.

There is additionally provided according to yet another aspect a dispensing mechanism for a bottle or cartridge configured to hold a fluent material. The dispensing mechanism includes a lever operable between a rest position and an engaged position, which causes a plunger to slidably engage an inner sidewall of the bottle and travel in a first direction towards an outlet of the bottle to expulse the fluent material therefrom. The dispensing mechanism includes a plate having a plate aperture. The plate is movable between an upper position and a lower position. The dispensing mechanism includes an elongate member passing through the plate aperture. The elongate member operatively couples to the plunger and extends along said first direction. Pivoting motion of the lever from the rest position to the engaged position causes the plate to bind with the elongate member and move in the first direction from the upper position to the lower position, with the plate and elongate member thereby causing the plunger to travel in the first direction. The dispensing mechanism includes a cap for attachment to an end of the bottle opposite the outlet. The lever pivotally couples to the cap. The cap encloses an interior. The plate is in fluid communication with the interior of the cap.

There is yet further provided according to an additional aspect a dispensing mechanism for a bottle or cartridge configured to hold a fluent material. The dispensing mechanism includes a lever operable between a rest position and an engaged position. This causes a plunger to slidably engage an inner sidewall of the bottle and travel in a first direction towards an outlet of the bottle to expulse the fluent material therefrom. The dispensing mechanism includes a plate having a plate aperture. The plate is movable between an upper position and a lower position. The dispensing mechanism includes an elongate member passing through the plate aperture. The elongate member operatively couples to the plunger and extends along said first direction. Pivoting motion of the lever from the rest position to the engaged position causes the plate to bind with the elongate member and move in the first direction from the upper position to the lower position, with the plate and the elongate member thereby causing the plunger to travel in said first direction. The dispensing mechanism includes a cap for attachment to an end of the bottle opposite the outlet. The lever pivotally couples to the cap. The lever, plate and cap are operatively connected together in a manner which facilitates cleaning thereof.

There is also provided according to another aspect a dispensing mechanism for a bottle or cartridge configured to hold a fluent material. The dispensing mechanism includes a lever operable between a rest position and an engaged position. This causes a plunger to slidably engage an inner sidewall of the bottle and travel in a first direction towards an outlet of the bottle to expulse the fluent material therefrom. The dispensing mechanism includes a plate having a plate aperture. The plate is movable between an upper position and a lower position. The dispensing mechanism includes an elongate member passing through the plate aperture. The elongate member operatively couples to the plunger and extends along said first direction. Pivoting motion of the lever from the rest position to the engaged position causes the plate to bind with the elongate member and move in the first direction from the upper position to the lower position, with the plate and the elongate member thereby causing the plunger to travel in said first direction. The dispensing mechanism includes a cap for attachment to an end of the bottle opposite the outlet. The cap has inner surfaces which are substantially exposed to facilitate cleaning thereof.

There is further provided according to yet another aspect a dispensing mechanism for a bottle or cartridge configured to hold a fluent material. The dispensing mechanism includes a lever operable between a rest position and an engaged position. This causes a plunger to slidably engage an inner sidewall of the bottle and travel in a first direction towards an outlet of the bottle to expulse the fluent material therefrom. The dispensing mechanism includes a plate having a plate aperture. The plate is movable between an upper position and a lower position. The dispensing mechanism includes an elongate member passing through the plate aperture. The elongate member operatively couples to the plunger and extends along said first direction. Pivoting motion of the lever from the rest position to the engaged position causes the plate to bind with the elongate member and move in the first direction from the upper position to the lower position, with the plate and the elongate member thereby causing the plunger to travel in said first direction. The dispensing mechanism includes a cap for attachment to an end of the bottle opposite the outlet. The cap has a downwardly-facing inner surface which is substantially exposed to facilitate cleaning thereof.

There is additionally provided according to a further aspect a dispensing mechanism for a bottle or cartridge configured to hold a fluent material. The dispensing mechanism includes a lever operable between a rest position and an engaged position. This causes a plunger to slidably engage an inner sidewall of the bottle and travel in a first direction towards an outlet of the bottle to expulse the fluent material therefrom. The dispensing mechanism includes a plate having a plate aperture that is polygonal in shape. The plate is movable between an upper position and a lower position. The dispensing mechanism includes an elongate member passing through the plate aperture. The elongate member operatively couples to the plunger and extends along the first direction. Pivoting motion of the lever from the rest position to the engaged position causes the plate to bind with the elongate member and move in the first direction from the upper position to the lower position, with the plate and the elongate member thereby causing the plunger to travel in said first direction. The elongate member is polygonal in outer shape.

There is also provided according to another aspect a dispensing mechanism for a bottle or cartridge configured to hold a fluent material. The dispensing mechanism includes a lever operable between a rest position and an engaged position. This causes a plunger to slidably engage an inner sidewall of the bottle and travel in a first direction towards an outlet of the bottle to expulse the fluent material therefrom. The dispensing mechanism includes a first plate having a plate aperture extending therethrough. The dispensing mechanism includes a spring-loaded second plate spaced-apart from the first plate. The second plate has a plate aperture and is movable between an upper position and a lower position. The dispensing mechanism includes an elongate member passing through the plate apertures. The elongate member is engageable with the plunger and extends along the first direction. The first plate is configured to inhibit linear movement of the elongate member opposite the first direction. Pivoting motion of the lever from the rest position to the engaged position causes the second plate to bind with the elongate member and move in the first direction from the upper position to the lower position, with the second plate and the elongate member thereby causing the plunger to travel in the first direction.

There is additionally according to another aspect a dispensing mechanism for a bottle or cartridge configured to hold a fluent material. The dispensing mechanism includes a lever operable between a rest position and an engaged position. The latter causes a plunger to slidably engage an inner sidewall of the bottle and travel in a first direction towards an outlet of the bottle to expulse the fluent material therefrom. The dispensing mechanism includes a pair of axially spaced plates. The dispensing mechanism includes an elongate member passing through respective apertures of the plates. A first said plate is spring-biased to inhibit translation of the elongate member opposite the first direction. A second said plate is neutrally spring-biased so as to allow free passage of the elongate member therethrough until the lever is moved towards the engaged position so as to cause the elongate member to engage with and bias the plunger to move along the first direction.

There is further provided according to an additional aspect a dispensing mechanism for a bottle or cartridge configured to hold a fluent material. The dispensing mechanism includes a lever. Actuation of the lever causes a plunger to slidably engage an inner sidewall of the bottle and travel in a first direction towards an outlet of the bottle to expulse the fluent material therefrom. The dispensing mechanism includes a handle towards which the lever is actuated. The handle includes at least one portion stop at a defined location along the path of travel of the lever. The distance traveled by the lever is limited by direct contact of the lever with the portion stop located within the path of travel, thereby limiting the distance traveled by the plunger to limit an expelled amount of the fluent material to a corresponding defined portion.

There is also provided according to a further aspect a dispensing mechanism for a bottle or cartridge configured to hold a fluent material. The dispensing mechanism includes a lever actuation of which causes a plunger to slidably engage an inner sidewall of the bottle and travel in a first direction towards an outlet of the bottle to expulse the fluent material therefrom. The dispensing mechanism includes a handle towards which the lever is actuated. The lever includes at least one portion stop having a defined shape, with the distance traveled by the lever limited by direct contact of the portion stop with a portion of the handle located within the path of travel of the lever. This thereby limits the distance traveled by the plunger to limit an expelled amount of the fluent material to a corresponding defined portion.

There is yet additionally provided according to another aspect a dispensing mechanism for a bottle or cartridge configured to hold a fluent material. The dispensing mechanism includes a cap for attachment to an end of the bottle. The dispensing mechanism includes a lever pivotally coupled to the cap. Actuation of the lever causes a plunger to slidably engage an inner sidewall of the bottle and travel towards an outlet of the bottle to expulse the fluent material therefrom. The lever includes a lengthened and/or enlarged side and/or rear portion and/or at least one rib. The dispensing mechanism includes a handle operatively connected to the cap and towards which the lever is actuated. The distance traveled by the lever is limited by direct contact of the lengthened and/or enlarged side and/or rear portion and/or at least one rib of the lever with a portion of the cap and/or handle located within the path of travel of the lever. This thereby limits the distance traveled by the plunger to limit an expelled amount of the fluent material to a corresponding defined portion.

There is also provided according to a further aspect a dispensing mechanism for a bottle or cartridge configured to hold a fluent material. The dispensing mechanism includes a cap for attachment to an end of the bottle. The dispensing mechanism includes a lever pivotally coupled to the cap, with actuation of the lever causing a plunger to slidably engage an inner sidewall of the bottle and travel towards an outlet of the bottle to expulse the fluent material therefrom. The lever includes a first of a female or male portion facing towards the handle in part. The dispensing mechanism includes a handle operatively connected to the cap and towards which the lever is actuated. The handle includes a second of the female and male portion facing the lever at least in part. The distance traveled by the lever is limited by direct contact of the female and male portions when the lever is actuated, thereby limiting the distance traveled by the plunger to limit an expelled amount of the fluent material to a corresponding defined portion.

It is emphasized that the invention relates to all combinations of the above features, even if these are recited in different claims.

Further aspects and example embodiments are illustrated in the accompanying drawings and/or described in the following description.

### BRIEF DESCRIPTION OF DRAWINGS

The accompanying drawings illustrate non-limiting example embodiments of the invention.

FIG. 1 is a front, left side, top perspective view of a fluent material dispensing system according to one aspect, the system including a dispensing mechanism and a cartridge connectable thereto;

FIG. 2 is a front, left side, top exploded view thereof, with the dispensing mechanism including a dispensing cap, a handle coupled to and extending upwards from the dispensing cap, a lever pivotally connectable to the dispensing cap, a portion ring rotatably connectable to the dispensing cap, a spring-biased upper plate, a lower plate positionable within an interior of the dispensing cap, and a rod slidably connectable to and extendable through the plates and dispensing cap, and with the cartridge including a bottle, a plunger slidably engageable with the bottle, a discharge cap positionable along the bottom of the bottle, and an outlet valve operatively connectable to the discharge cap;

FIG. 3 is a front, left side, top exploded view of the fully assembled dispensing mechanism and the fully assembled cartridge of FIG. 1;

FIG. 4 is a rear, left side, top perspective view of the portion ring of the dispensing mechanism of FIG. 3;

FIG. 5 is a rear, left side, top perspective view of the dispensing cap and handle of the dispensing mechanism of FIG. 3, with the lever, portion ring and rod being removed/not-shown;

FIG. 6 is a front, left side, top view of the lever of the dispensing mechanism of FIG. 3;

FIG. 7 is a sectional view taken along lines 7-7 of the dispensing mechanism of FIG. 3, with the portion ring and rod thereof being removed/not-shown;

FIG. 8 is a front, bottom, left side perspective view of the dispensing mechanism of FIG. 3, with the rod thereof being removed/not-shown;

FIG. 9 is a sectional view taken along lines 9-9 of the fluent material dispensing system of FIG. 1, with the lever and upper plate being shown in non-actuated positions;

FIG. 10 is a sectional view thereof similar to FIG. 9, with the lever and upper plate being shown in actuated positions so as to engage the rod and cause the rod to move downwards so as to bias the plunger downwards towards the bottom of the bottle to expel fluent material from the outlet valve thereof, with the lever so actuated engaging a portion stop of the portion ring of the dispensing mechanism;

FIG. 11 is a front, left side, top perspective view of a fluent material dispensing system according to another aspect, with the system including a cartridge and a dispensing mechanism coupled thereto;

FIG. 12 is a sectional view taken along lines 12-12 of the fluent material dispensing system of FIG. 11;

FIG. 13 is a front, bottom, left side perspective view of the dispensing mechanism of FIG. 11, with the rod thereof being removed/not-shown;

FIG. 14 is a front, left side, top exploded view of the fluent material dispensing system of FIG. 11, with the dispensing mechanism including a dispensing cap, a handle coupled to and extending upwards from the dispensing cap, a lever pivotally connectable to the dispensing cap, a spring-biased upper plate connectable to the handle, a spring-biased lower plate positionable within an interior of the dispensing cap, and a rod slidably connectable to and extendable through the plates and dispensing cap, and with the cartridge including a bottle, a plunger slidably engageable with the bottle, a discharge cap positionable along the bottom of the bottle, and an outlet valve operatively connectable to the discharge cap;

FIG. 15 is a front, left side, top exploded view of the fully assembled dispensing mechanism and fully assembled cartridge of FIG. 11, with the lever being shown in a non-actuated position;

FIG. 16 is a rear, left side, top perspective view of the fluent material dispensing system of FIG. 11, with the lever being shown in an actuated position;

FIG. 17 is a sectional view taken along lines 17-17 thereof, with the lever so actuated causing the upper plate to move towards a non-angled position which enables translation of the elongate member and causing the lower plate to move towards an angled position so as to engage the elongate member and cause the elongate member to move downwards so as to bias the plunger downwards towards the bottom of the bottle to expel fluent material from the outlet valve; and

FIG. 18 is a front, right side, top view of the lever of a dispensing mechanism of a fluent material dispensing system according to a further aspect.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

As mentioned above, U.S. Pat. No. 8,511,520 to van Wijke et al. filed in the United States Patent and Trademark Office on 23 Feb. 2012, discloses a fluent material dispensing system, the disclosure of which is incorporated herein by reference.

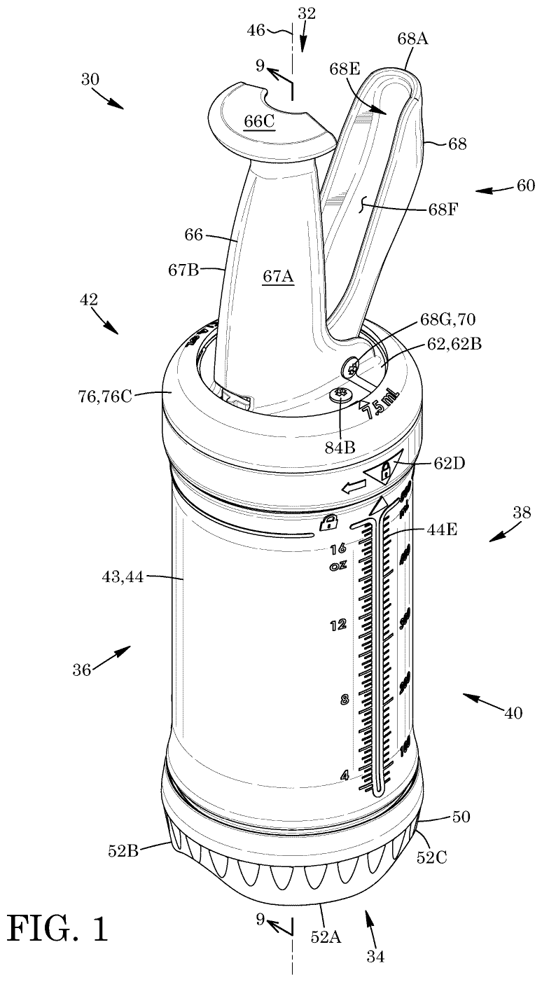

Referring to the drawings and first to FIG. 1, there is shown an improved fluent material dispensing system 30. The system includes a top 32, bottom 34 spaced-apart from the top thereof, a front 36, a rear 38 spaced-apart from the front thereof, a left side 40 and a right side 42 spaced-apart from the left side thereof.

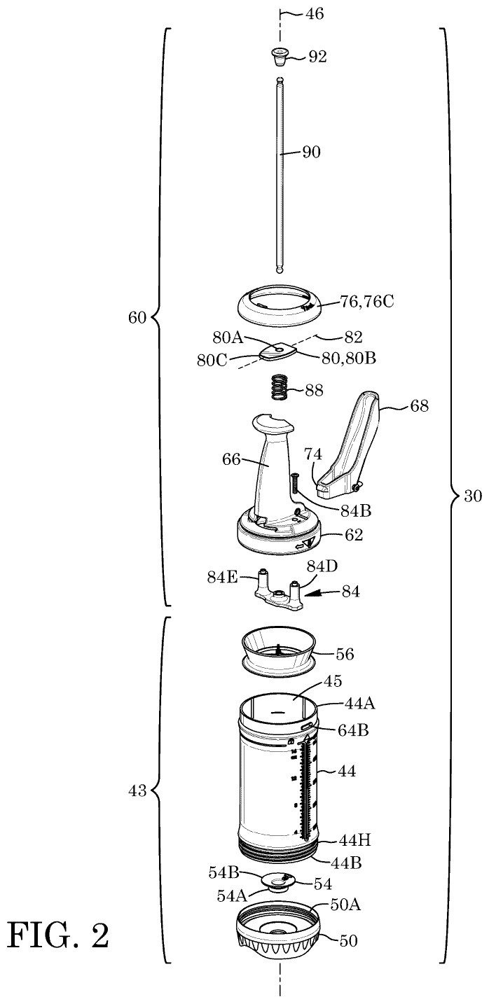

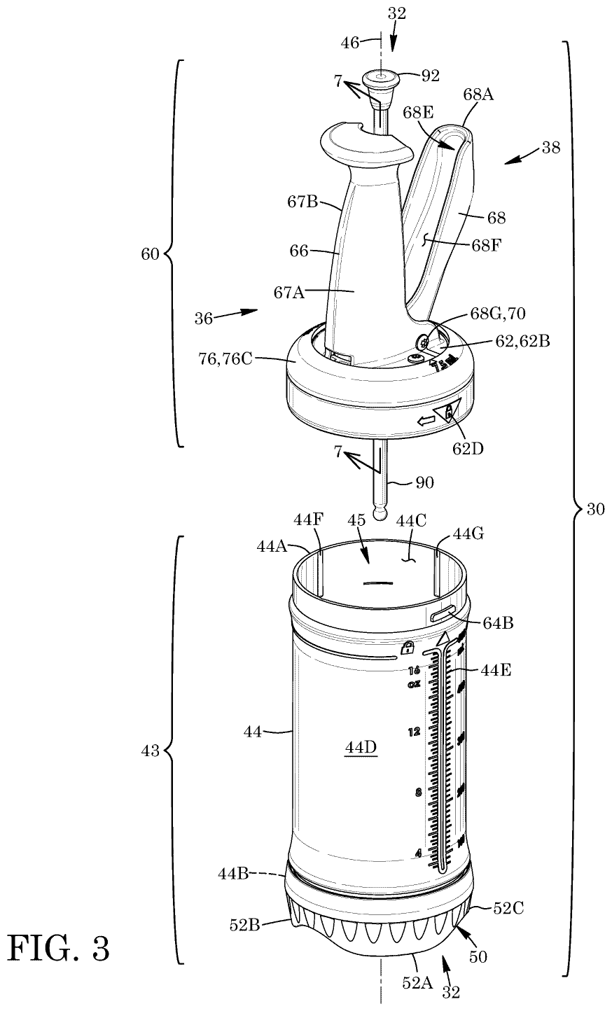

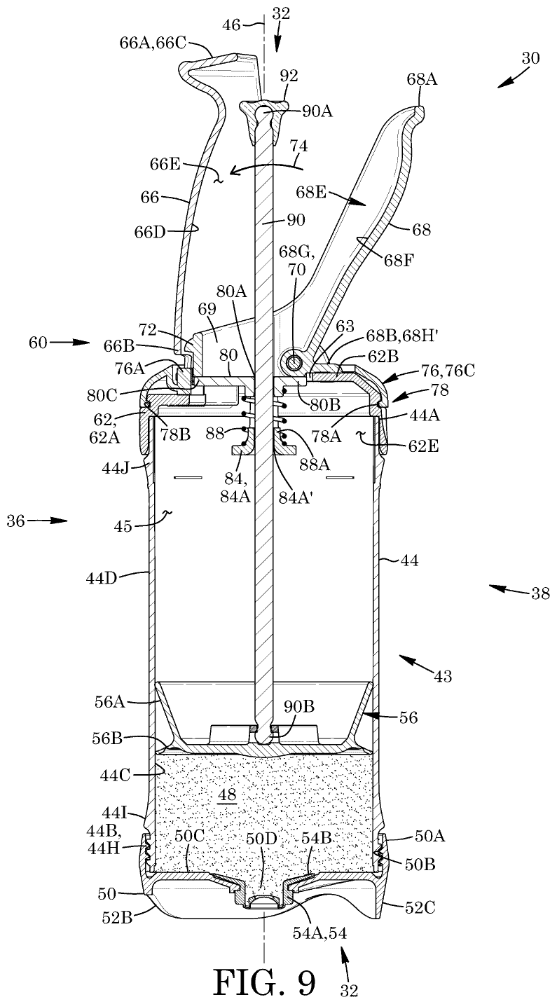

As seen in FIG. 2, fluent material dispensing system 30 includes a cartridge 43. The cartridge includes a bottle 44. The bottle is hollow and generally cylindrical in outer shape in this non-limiting embodiment; however, the latter is not strictly required. As seen in FIG. 3, bottle 44 has an open end or top 44A, a bottom 44B spaced-apart from the top thereof and inner sidewall 44C extending between the top and bottom thereof. The bottle has an outer surface 44D extending between top 44A and bottom 44B thereof. The outer surface of bottle 44 in this non-limiting example has measurement indicia 44E thereon. The bottle in this non-limiting example includes one or more channels 44F and 44G formed in a region of inner sidewall 44C thereof the bottle. Bottle 44 has an interior 45 enclosed by inner sidewall 44C thereof. The interior of the bottle is in fluid communication with channels 44F and 44G, with an inner diameter that has a draft or taper; however, neither the former nor the latter is strictly required. Bottle 44 extends along a longitudinal axis 46 passing through a center thereof and extending between top 44A and bottom 44B thereof. As seen in FIG. 9, the bottle is shaped to receive fluent material 48 therein and configured to selectively dispense or expulse the same therefrom.

Referring to FIG. 2, cartridge 43 in this non-limiting example includes a first or discharge cap 50. The discharge cap may be referred to as a first or lower cartridge cap or bottle cap. Referring back to FIG. 9, discharge cap 50 includes a sleeve portion 50A which extends about axis 46. The discharge cap is configured to operatively couple to bottom 44B of bottle 44 via the sleeve portion thereof: in this non-limiting example the discharge cap threadably couples to bottle 44 via exterior threading 44H of the bottle adjacent the bottom thereof, with the exterior threading threadably coupling to interior threading 50B of the discharge cap.

Discharge cap 50 includes a flange portion 50C coupled to and extending radially/laterally inwards from sleeve portion 50A thereof. The flange portion is annular in this example with an aperture 50D extending centrally therethrough. As seen in FIG. 1, discharge cap 50 in this non-limiting example includes a plurality of longitudinally-extending protrusions or legs 52A, 52B and 52C. The legs extend circumferentially about axis 46 with recessed portions positioned therebetween; however, this is not strictly required. Fluent material dispensing system 30 is configured to rest in an upright position so as to extend substantially along and about the axis via legs 52A, 52B and 52C of discharge cap 50. Sleeve portion 50A, flange portion 50C and the legs of the discharge cap are integrally connected together in this non-limiting embodiment so as to form a unitary whole.

As seen in FIG. 2, cartridge 43 includes a valve, in this example an outlet valve 54. Discharge cap 50 is configured for seating the valve thereon. Bottle 44 may thus be said to include an outlet adjacent bottom 44B thereof in this non-limiting example, with the bottom of the bottle otherwise being closed. In addition or alternatively, the outlet of the bottle may be said to include valve 54. The valve is made of an elastomer, in this non-limiting example pliant vulcanized silicone. As seen in FIG. 9, valve 54 includes a sleeve portion 54A which extends along and about axis 46 in this non-limiting example, as well as a flange portion 54B coupled and extending radially/laterally outwards from the sleeve portion thereof. The sleeve portion of the valve extends axially downwards through aperture 50D of discharge cap 50 and the flange portion of the valve is configured to abut and/or be received by flange portion 50C of the discharge cap. Valve 54 is configured to be normally closed so as to inhibit fluent material 48 from passing therethrough. Many different types of valves may be provided, such as one or more valves for example described in U.S. patent application Ser. No. 18/645,059 to Fisher filed in the United States Patent and Trademark Office on 24 Apr. 2024, the disclosure of which is incorporated herein by reference.

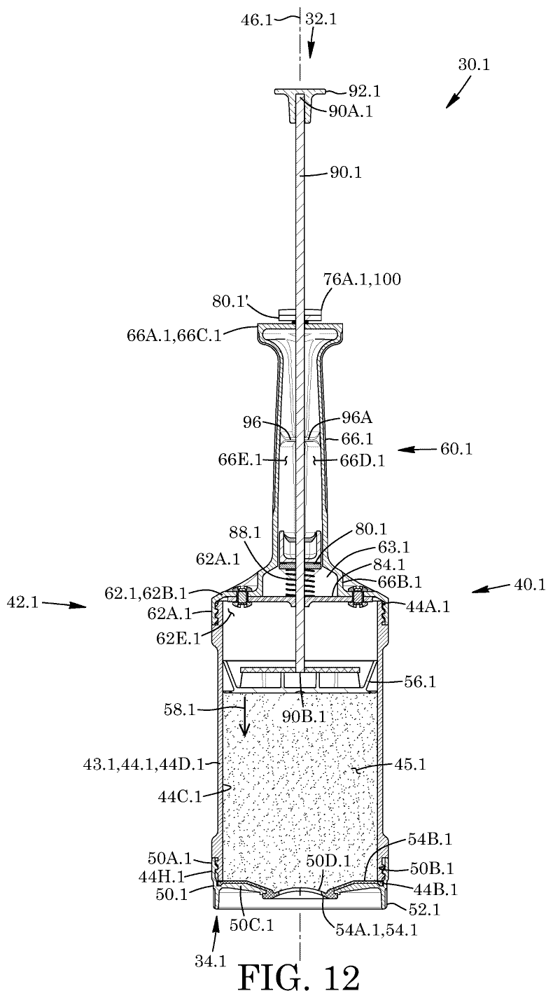

As seen in FIG. 9, bottle 44 includes in this non-limiting example a first annular stop, in this non-limiting example a first annular flared portion 44I adjacent exterior threading 44H thereof. The first flared portion flares radially outwards in a downward direction from the perspective of FIG. 9. First flared portion 44I is shaped to inhibit discharge cap 50 from over rotation. This also allows valve 54 in the form of a silicone gasket seen in FIG. 12 to be used in the case of larger orifice valves, prevents over tightening and rotation of the valve to maintain the desired compression, and functions to prevent/minimize compression set.

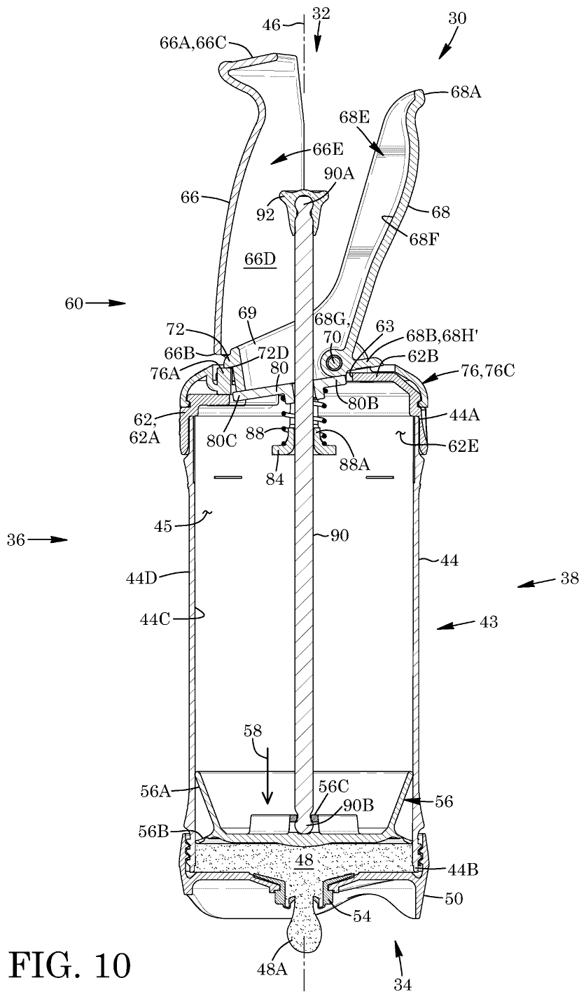

As seen in FIG. 2, cartridge 43 includes a plunger 56. The plunger is made of a polymer, in this non-limiting example being a hybrid of mainly low-density polyethylene and polyoxymethylene. Referring to FIG. 10, the plunger is configured to exert a compressive force on fluent material 52 when traveling through interior 45 of bottle 44 in a first direction 58. This causes valve 54 to actuate or move towards an at least partially open position to thereby facilitate expulsion of the fluent material therethrough as seen by numeral 48A. The following is a non-limiting embodiment that achieves this functionality.

Plunger 56 includes in this example two spaced-apart, flexible flanges, in this case an upper flange 56A and a lower flange 56B configured for frictional engagement with inner sidewall 44C of bottle 44 as the plunger moves in first direction 58. One of the flexible flanges, in this non-limiting example the upper flange extends at an angle toward the sidewalls of the bottle and opposite the first direction. Upper flange 56A is thereby configured to exhibit a reduced compliance when subjected to the force oriented opposite first direction 58. The reduced compliance relative to compliance of the upper flange during travel in the first direction, facilitates frictional engagement of the upper flange with inner sidewall 44C for holding plunger 56 substantially in place against the force oriented opposite the first direction. Thus, the friction of the plunger caused by engagement with inner sidewall 44C of bottle 44 prevents or inhibits rod 90 from translating until actuated via lever 68 and plate 80. Channels 44F and 44G of bottle 44 seen in FIG. 3 are free from occupation by the plunger and facilitate expulsion of air from the bottle and around the plunger as the plunger is brought into contact with the fluent material, thereby inhibiting inadvertent fluent material escape during assembly of fluent material dispensing system 30.

Still referring to FIG. 3, the fluent material dispensing system includes a dispensing mechanism 60. In some embodiments the plunger may be said to be a part of the dispensing mechanism; however, this is not strictly required.

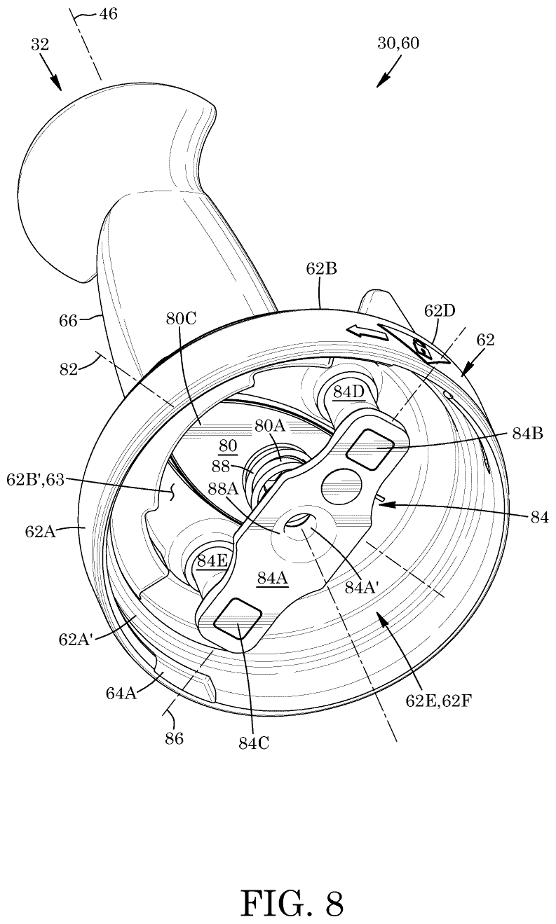

As seen in FIG. 5, dispensing mechanism 60 includes a second or dispensing cap 62. The dispensing cap may be referred to as a second or upper bottle cap. Referring to FIGS. 3 and 8, dispensing cap 62 is configured for attachment to open top 44A of bottle 44: in this non-limiting example the dispensing cap has a bayonet thread 64A seen in FIG. 8 which screws onto bayonet pins 64B at the top of the bottle seen in FIG. 3. Referring back to FIG. 5, the dispensing cap has a sleeve portion 62A which extends about axis 46 and a top portion 62B coupled to and radially/laterally-extending inwards from the sleeve portion thereof. The top portion of dispensing cap 62 is circular in this non-limiting example and has an aperture 63 extending therethrough. Sleeve portion 62A and top portion 62B of the dispensing cap are integrally connected together so as to form a unitary whole in this non-limiting embodiment. Dispensing cap 62 includes in this example a circumferentially spaced gripping indentations 62C along the exterior of sleeve portion 62A thereof so as to promote gripping thereof. The dispensing cap includes in this example an indicia 62D along the exterior of the sleeve portion and which is configured to align with indicia 44E of bottle 44 seen in FIG. 1 when the dispensing cap is fully coupled-to/locked-with the bottle. The sleeve and top portions of dispensing cap 62 define and function to enclose at least in part an interior 62E of the dispensing cap seen in FIG. 8. Bayonet thread 64A is in fluid communication with the interior of the dispensing cap. Dispensing mechanism 60 as herein described is configured to be backwards compatible with other components.

As seen in FIG. 9, bottle 44 includes in this non-limiting example a second annular stop, in this non-limiting example a second annular flared portion 44J. The second flared portion flares radially outwards in an upward direction from the perspective of FIG. 9. Second flared portion 44J is positioned adjacent sleeve portion 62A of dispensing cap 62.

Dispensing cap 62 is shaped to facilitate cleaning thereof. The following is a non-limiting embodiment which achieves this functionality. As seen in FIG. 8, dispensing cap 62 has an open bottom 62F with inner surfaces which are substantially exposed to facilitate cleaning thereof. These surfaces include an interior or inner surface 62A′ of sleeve portion 62A of the dispensing cap as well as an interior or downwardly-facing inner surface 62B′ of top portion 62B of the dispensing cap. The downwardly-facing inner surface of the top portion of dispensing cap 62 is substantially exposed.

Referring to FIG. 5, dispensing mechanism 60 includes a handle 66. The handle is elongate and has an upper end or top 66A and a lower end or bottom 66B spaced-apart from the bottom thereof. The bottom of handle 66 couples to and extending upwards from top portion 62B of dispensing cap 62. Bottom 66B of the handle is bracket-shaped at least in part in this example. Handle 66 in this non-limiting embodiment is integrally connected to dispensing cap 62 so as to form a unitary whole; however, this is not strictly required. Top 66A of the handle is closed at least in part in this example. Handle 66 in this non-limiting example includes a flange 66C along the top thereof. The flange is laterally-extending and semi-circular in this non-limiting embodiment. Referring to FIG. 10, flange 66C is configured to rest on a user's hand so that dispensing mechanism 60 can be held in an ungrasped manner with the user's hand being between the flange and outlet valve 54. Handle 66 extends along longitudinal axis 46 of bottle 44 between top 66A and bottom 66B thereof. The handle extends away from the bottle along the longitudinal axis which is aligned with first direction 58 and which passes substantially through the center of the bottle in this non-limiting example. As seen in FIG. 5, handle 66 has a pair of spaced-apart sides 67A and 67B extending between top 66A and bottom 66B thereof.

Handle 66 is shaped to facilitate cleaning thereof. The following is a non-limiting embodiment which achieves this functionality. As seen with reference to FIGS. 5 and 10, handle 66 in this example is continuously open along an interior side 66D from top 66A to bottom 66B thereof. The handle defines a continuous path or open interior 66E between the bottom and top thereof. Handle 66 is C-shaped in lateral section in this non-limiting example.

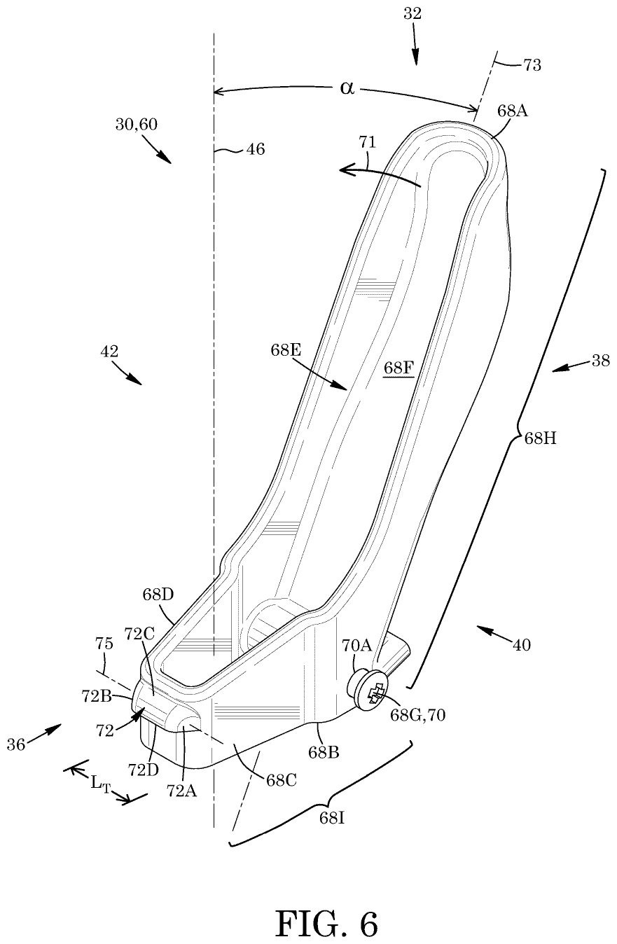

As seen in FIG. 3, dispensing mechanism 60 includes a lever 68. Referring to FIG. 6, the lever is elongate, with an upper end or open top 68A and a lower end or bottom 68B spaced-apart from the top thereof. Lever 68 is operable between a non-actuated or rest position seen in FIG. 9 and an actuated or engaged position seen in FIG. 10. Referring back to FIG. 6, lever 68 when in its non-engaged or rest position, extends along a longitudinal axis 73 between the bottom and top thereof. The longitudinal axis of the lever is angularly spaced from longitudinal axis 46 of the bottle by angle α which is acute in this example. Actuation of lever 68 in direction 71 reduces this angle as the lever moves towards axis 46. The lever has a first or left side 68C and a second or right side 68D spaced-apart from the left side thereof.

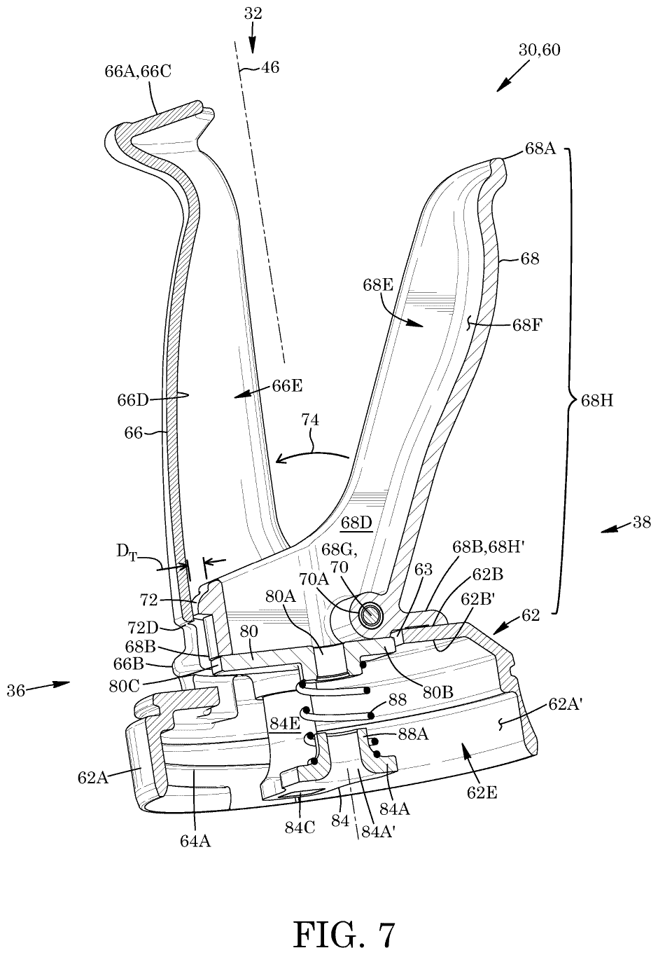

Lever 68 is shaped to facilitate cleaning thereof. The following is a non-limiting embodiment which achieves this functionality. Lever 68 in this example is continuously open and defines an open interior 68E along an interior side 68F from top 68A to bottom 68B thereof. The lever thus defines a continuous path between the bottom and top thereof. Lever 68 is C-shaped in lateral section in this non-limiting example. As seen in FIG. 7, open interior 68E of the lever faces open interior 66E of handle 66 in this non-limiting embodiment. Lever 68 thus defines a space that is continuously open in a direction facing the handle between top 68A and bottom 68B of the handle and the handle may thus be said to define a space that is continuously open in a direction facing the lever between top 66A and bottom 66B of the lever.

The lever and dispensing cap 62 are operatively connected together in a manner which facilitates cleaning thereof. In this example bottom 68B of lever 68 pivotally couples to the dispensing cap about a fulcrum 68G via an elongate metal member or fastener assembly: this may comprise a fastener and a barrel nut shaped to threadably couple thereto and/or may comprise a sex bolt 70 in this non-limiting example which extends through laterally-extending bore or aperture 70A. As a further alternative, a barrel screw/nut may be provided, or a spring, a cotter pin, a clevis pin and/or a set of spring loaded plungers. One or more of these features may be referred to as a bearing pin and/or alternatively, lever 68 may couple to dispensing cap 62 via a bearing pin in other embodiments. Fulcrum 68G thus aligns with or is coaxial with sex bolt 70 in this example. The sex bolt extends between sides 67A and 67B of handle 66 and may be referred to as a full-length fastener or connector. Sex bolt 70 and/or bearing pin is made of stainless steel in this non-limiting example. Fluent material dispensing system 30 so configured with its full-length sex bolt and/or stainless steel shaft and as herein described may thus comprise a system that is more robust and wear-resistant. This is in contrast to the system of U.S. Pat. No. 8,511,520, which discloses plastic rotation pins that may get damaged over time due to aggressive use and/or misassembly, for example.

Referring back to FIG. 6, lever 68 includes a hand-actuated portion 68H extending from top 68A towards bottom 68B thereof and a plate-contacting portion 68I extending from the bottom towards top thereof. The hand-actuated portion and plate-contacting portion of the lever are located on opposite sides of fulcrum 68G. Hand-actuated portion 68H of the lever seen in FIG. 6 is longer than plate-contacting portion 68I of the lever so as to provide a mechanical advantage when the lever is moved or actuated from its rest position to its engaged position.

As seen in FIG. 7, handle 66 is thus operatively connected to lever 68. The lever may thus be said to pivotally couple to and/or relative to the handle. Lever 68 and handle 66 are shaped to facilitate cleaning thereof without requiring disassembling thereof.

Lever 68 includes a protuberance, in this example a tooth 72. The tooth is configured to extend outwards a defined distance DT along a path of travel 74 of the lever. Tooth 72 is adjacent or in this example near bottom 68B of lever 68 in this non-limiting example. The tooth is configured to cantilever outwards from the lever in this example. Hand-actuated portion 68H of lever 68 includes a sub-portion 68H′ thereof which is adjacent bottom 68B of the lever and which is configured to abut and extend flush with top portion 62B of dispensing cap 62 in the rest position of the lever. The bottom and sub-portion of the lever are angled relative to the top portion of the dispensing cap in the actuated position of the lever seen in FIG. 10.

Lever 68 is configured to be received at least in part within handle 66 when actuated. Actuation of the lever from the rest position seen in FIG. 9 to the engaged position seen in FIG. 10, causes plunger 56 to slidably engage along inner sidewall 44C of bottle 44 and travel in first direction 58 towards outlet valve 54 of the bottle to expulse fluent material 48 therefrom as shown by numeral 48A. A distance traveled by the plunger in the first direction increases with a distance traveled by the lever from the rest position to the engaged position. Plunger 56 is configured to frictionally engage inner sidewall 44C of bottle 44 to a degree sufficient for holding the plunger substantially in place against a force oriented opposite the first direction, with said force being applied by dispensing mechanism 60 due to the pivoting return motion of lever 68.

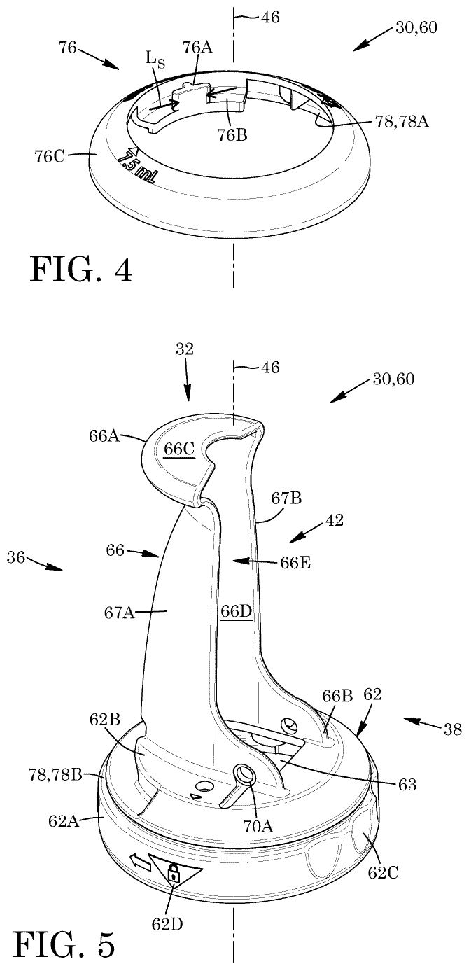

Referring to FIG. 4, the dispensing mechanism includes a portioning mechanism 76. The portioning mechanism is configured to limit the distance traveled by lever 68 from its rest position seen in FIG. 9 to its engaged position seen in FIG. 10 to a defined amount, thereby limiting the distance traveled by plunger 56 to limit an expelled amount of fluent material 48 to a corresponding defined portion 48A. The following is a non-limiting embodiment which achieves this functionality.

Referring to FIG. 4, portioning mechanism 76 is configured to limit the distance traveled by the lever to a defined amount, with the portioning mechanism in this non-limiting embodiment comprising one or more and in this example a plurality of portion stops, in this non-limiting example a first portion stop 76A and an alternate or second portion stop 76B. The second portion stop is axially/longitudinally spaced from and in this example below the first portion stop from the perspective of FIG. 5. There may be yet further portion stops in other embodiments. Portion stops 76A and 76B are in this non-limiting example coupled to and a part of a portion ring 76C, which may be said to be a part of dispensing mechanism 60 (and/or portioning mechanism 76 thereof). The portion ring operatively connects to and is rotatable relative to lever 68 seen in FIG. 9.

Portion ring 76C in this non-limiting embodiment rotatably and slidably couples to dispensing cap 62 about axis 46, in this non-limiting example via a tongue and groove connection 78. The tongue and groove connection in this non-limiting example comprises: a radially/laterally-extending flange 78A coupled to a first of the portion ring and dispensing cap, in this example the portion ring adjacent the bottom thereof; and an annular recess 78B or groove being part of a second of the portion ring and dispensing cap, in this example the dispensing cap between sleeve portion 62A and top portion 62B thereof. Rotation of portion ring 76C enables replacement of first portion stop 76A seen in FIG. 4 with second portion stop 76B, enabling lever 68 seen in FIG. 10 to travel along a greater distance where a greater portion size is desired, for example.

The lever, when engaged/actuated, subjects portion ring 76C (and respective portion stop 76A thereof) to a load via tooth 72. The distance traveled by lever 68 is limited by direct contact of the tooth with the respective portion stop located within path of travel 74. This thereby limits the distance traveled by plunger 56 towards valve 54 and thus limits an expelled amount of fluent material 48 to a corresponding defined portion 48A. A given/selected portion stop 76A thus defines the engaged position of lever 68. The portion stop is configured to maintain its defined location relative to motion of dispensing mechanism 60. Portion stop 76A is replaceable with alternate portion stop 76B seen in FIG. 5 placed at an alternate defined location along the path of travel of the lever. The alternate portion stop defines an alternate engaged position different from the engaged position, thereby limiting the expelled amount of the fluent material to a different defined portion. Portion stops 76A and 76B are in fixed positions relative to dispensing cap 62 during operation of lever 68 seen in FIG. 10. Defined portion(s) 48A comprises up to and including one ounce according to one non-limiting embodiment, greater than one ounce in another non-limiting example, and between one to two ounces in a further non-limiting embodiment.

Tooth 72 of lever 68 is shaped to promote spreading out of the load on portion ring 76C (and/or respective portion stop 76A thereof) so as to inhibit damage and/or wear thereto and/or deformation thereof. The following is non-limiting embodiment which achieves this functionality.

As seen in FIG. 6, tooth 72 includes a first end portion 72A and a second end portion 72B spaced-apart from the first end portion thereof. The first end portion of tooth is adjacent left side 68C of lever 68 in this example and the second end portion of the tooth is adjacent right side 68D of the lever in this example. Tooth 72 extends along a longitudinal axis 75. The top and forward or front of the tooth is curved in this non-limiting example, in this case comprising an outwardly convex shape/surface 72C. Tooth 72 is generally or substantially triangular in lateral section in this non-limiting example. Each end portion 72A and 72B of the tooth is outwardly convex at least in part longitudinally and laterally in this non-limiting example. Each end portion of tooth 72 is generally or substantially quarter spherical in shape in this non-limiting embodiment. The tooth selectively engages portion stop 72A seen in FIG. 10 via a loading bearing surface 72D. Referring back to FIG. 6, the loading bearing surface of tooth 72 in this embodiment is planar and elongate. Loading bearing surface 72D of the tooth is in this non-limiting example rectangular in shape.

Tooth 72 has a length Lr extending parallel to longitudinal axis 75 thereof and between end portions 72A and 72B thereof. The length of the tooth extends generally and/or substantially perpendicular to path of travel 74 seen in FIG. 7. Length L_{T} of tooth 72 seen in FIG. 6 is larger than defined distance Dr seen in FIG. 7 in this example. The length of the tooth is in this non-limiting embodiment larger than the length of respective portion stops as seen by length L_{S} of portion stop 76A seen in FIG. 4; however, this is not strictly required. Referring back to FIG. 6, tooth 72 is configured to be enlarged and/or thus comprises an enlarged said load bearing surface 72D. The tooth may be referred to as an enlarged tooth configured to spread the load on portion ring 76C, resulting-in-less and/or inhibiting local deformation thereof and/or thereon. Compared to the system shown in U.S. Pat. No. 8,511,520, load bearing surface 72D of tooth 72 of dispensing mechanism 60 as herein described may be at least doubled according to one embodiment, increased by at least 75% according to another non-limiting embodiment, and increased by 78% according to an additional non-limiting embodiment.

Dispensing mechanism 60 (and/or the tooth and portion ring thereof) as herein described may thus be said to comprise a more robust solution that inhibits variance in portioning of fluent material over time that may otherwise arise from wear, fatigue, deformation and the like, thus reducing wear and tear on portioning ring 76C. Lever 68 and tooth 72 seen in FIG. 9 are made of a polymer or plastic that is relatively and/or more rigid, in this non-limiting example polypropylene (PP); however, this is not strictly required and other materials may be used in other embodiments, such as polyoxymethylene (POM), acetal plastic or the like. The latter may function to likewise increase robustness and provide a low friction solution for pivoting parts thereof. Dispensing cap 62 and handle 66 are also in this non-limiting example made of a polymer or plastic that is relatively and/or more rigid. Fluent material dispensing mechanism 30 as herein described is configured to enable stronger/stiffer plastic to be used to enhance robustness thereof. Handle/lever ribs from the system of U.S. Pat. No. 8,511,520 have been removed to enhance cleanability of dispensing mechanism 60.

As seen in FIG. 2, dispensing mechanism 60 includes a first or upper plate 80. The plate may be referred to as a push plate, a spring-biased plate or a spring plate, for example. Plate 80 is planar and rectangular in this example. The plate is made of metal, in this example sintered metal in this non-limiting embodiment. Plate 80 is configured to enhance robustness and cleanability of dispensing mechanism 60 and is in contrast to the system of U.S. Pat. No. 8,511,520, which may disclose a plastic push plate. The plate is made of stainless steel in this non-limiting embodiment. Plate 80 extends along a longitudinal axis 82 that is generally or substantially perpendicular to longitudinal axis 46 of bottle 44 in this non-limiting embodiment. As seen in FIG. 7, the plate has a plate aperture 80A extending therethrough. The plate aperture is off-center and coaxial with the longitudinal axis of the bottle in this non-limiting example. Plate 80 includes a first or proximal end 80B and a second or distal end 80C spaced-apart from the proximal end thereof. Plate aperture 80A is closer to the proximal end than the distal end of the plate in this non-limiting example. Proximal end 80B of plate 80 abuts and/or is adjacent fulcrum 68G in this non-limiting embodiment. The plate is selectively tiltable, with distal end 80C thereof being movable between a first or upper position seen in FIG. 9 in the rest position of lever 68 and a second or lower position seen in FIG. 10 in the actuated position of the lever. Proximal end 80B of plate 80 has a first or lower position seen in FIG. 9 in the rest position of the lever and a second or upper position seen in FIG. 10 in the actuated position of the lever. The plate may thus be said to be movable between upper and lower positions. Plate 80 is biased towards a non-angled position in this example.

The plate couples to and is spring-biased axially upwards relative to dispensing cap 62 in a manner which facilitates cleaning thereof. The following is a non-limiting embodiment which achieves this functionality. As seen in FIG. 8, plate 80 couples to dispensing cap 62 in a manner that promotes fluid communication of the plate with interior 62E of dispensing cap 62. The plate is configured to couple to the dispensing cap in a manner which enables the plate to be fully and/or substantially exposed to open bottom 62F of the dispensing cap to facilitate cleaning thereof. Dispensing mechanism 60 may thus be said to comprise an open bottom or underneath portion thereof for cleanability. Access to plate 80 may thus be said to be enhanced/opened compared to the system shown in U.S. Pat. No. 8,511,520, and this may function to reduce material/plastic costs and enhance cleanability. Dispensing mechanism 60 as herein described may be said to comprise a more open geometry and/or be configured to promote an open geometry to enhance/facilitate cleanability thereof.

Dispensing mechanism 60 includes a mount 84 via which plate 80 couples to dispensing cap 62. The mount may be referred to as a plate holder or spring plate holder, for example. Mount 84 includes a planar member or lower plate 84A in this non-limiting embodiment. The lower plate of the mount is planar and generally rectangular in shape in this example. Lower plate 84A of mount 84 is axially spaced from upper plate 80. The lower plate of the mount extends along a longitudinal axis 86 which is angled and/or generally or substantially perpendicular to longitudinal axis 82 of upper plate in this non-limiting example. Lower plate 84A of mount 84 is angled and in this example generally or substantially perpendicular to axis 46 in this non-limiting embodiment. The lower plate of the mount couples to and is positioned within interior 62E of dispensing cap 62. Lower plate 84A of mount 84 has an aperture 84A′ extending therethrough and which is coaxial with axis 46 and aperture 80A of upper plate 80 in this example. The lower plate of the mount couples to top portion 62B of dispensing cap 62 in this non-limiting example via a pair of spaced-apart fasteners 84B and 84C. The fasteners are configured to only require a screwdriver to threadably couple the lower plate of the mount to the dispensing cap: the fasteners have square heads in this non-limiting embodiment to achieve this functionality. Handle 66 thus operatively couples to upper plate 80 and lower plate 84A. Fasteners 84B and 84C are enclosed by sleeves 84D and 84E in this example. Each sleeve is in fluid communication with interior 62E of dispensing cap 62. Plate 80 is positioned between fasteners 84B and 84C and sleeves 84D and 84E in this example. Mount 84 may be said to include the fasteners and sleeves.

Dispensing mechanism 60 includes a resilient member, in this example a spring 88. As seen in FIG. 9, the spring is configured to be positioned in place via a spring boss 88A coupled to lower plate 84A of mount 84. Spring 88 is positioned between upper plate 80 and lower plate 84A of the mount. The upper plate couples to mount 84 and is spring-biased axially upwards relative via the spring. Spring 88 is configured to bias plate 80 towards a non-angled position and to maintain contact with lever 68 during motion of the lever seen in FIGS. 9 and 10. Referring back to FIG. 8, the spring is in fluid communication with interior 62E of dispensing cap 62 to facilitate cleaning thereof. Spring 88 is fully exposed to open bottom 62F of the dispensing cap to facilitate cleaning thereof.

Referring to FIG. 9, dispensing cap 62, handle 66, lever 68, plate 80, mount 84 and spring 88 are thus operatively connected together so as to comprise one part. The dispensing cap, handle, lever, plate, mount and spring as herein described are coupled together in a manner which facilitates cleaning thereof without requiring disassembling of any constituent parts thereof. Fluent material dispensing system 30 as herein described may comprise a dispensing system that reduces the effective part count from four or five (see parts set out in FIGS. 2A to 2C of U.S. Pat. No. 8,511,520) to effectively one piece/part. Fluent material dispensing system 30 is further configured to reduce the volume of material or plastic used by at least approximately 10%, in this non-limiting example. Handle 66 and lever 68 may be referred to as a handle assembly, with dispensing mechanism 60 as herein described being configured to enable cleaning of the entire handle assembly as one unit. The dispensing mechanism as herein described may thus function to facilitate cleaning thereof on the one hand, in a manner that promotes efficiency/time-savings on the other hand.

Dispensing mechanism 60 includes an elongate member, in this example a rod 90. The rod is substantially cylindrical in shape in this non-limiting embodiment and round or circular in lateral section. Rod 90 has a first or upper end 90A a second or lower end 90B spaced-apart from the upper end thereof. Each end of the rod is in this non-example configured for coupling thereto and in this case comprises a spherical ball-shaped end; however, this is not strictly required. Rod 90 extends along axis 46 of bottle 44 between the ends thereof. Dispensing mechanism 60 in this non-limiting example includes a gripping member, cap or knob 92 coupled to upper end 90A of the rod; however, this too is not strictly required. Rod 90 extends through aperture 63 formed in dispensing cap 62. The rod extends through an aperture, gap or passageway 69 formed within lever 68 near or adjacent bottom 68B of the lever. The passageway may be located between hand-actuated portion 68H of the lever seen in FIG. 6 and plate-contacting portion 68I of the lever in this non-limiting embodiment. Referring back to FIG. 9, the plate-contacting portion of lever 68 and portion stop 76A may be located on the same side of the passageway; however, here too this is not strictly required. Rod 90 is additionally shaped to pass through plate apertures 80A and 84A′. Lower plate 84A is configured to promote and/or facilitate alignment of the rod relative to plunger 56. In this non-limiting example the lower plate is elongate and generally or substantially spans the lateral extent of sleeve portion 62A of dispensing cap 62, which may function to further promote rod alignment.

As seen in FIG. 10, rod 90 extends along/parallel-to first direction 58. Lower end 90B of the rod is configured in this non-limiting embodiment to be engageable with plunger 56 along the first direction, that is, when the rod is lowered downwards from the perspective of FIG. 10. Rod 90 thus operatively couples to the plunger. In this non-limiting example plunger 56 includes a socket and/or resilient clip 56C configured for mating engagement with lower end 90B of the rod in response to an engagement force applied to the rod in first direction 58. Rod 90 may thus be said to couple to the plunger via a ball and socket joint in this non-limiting example. The engagement force is insufficient to overcome frictional engagement of the plunger with inner sidewall 44C of bottle 44, thereby allowing engagement of rod 90 with plunger 56 without undesired travel of the plunger and corresponding dispensing of fluent material 48.

Mount 84 and/or plate 84A may be configured to inhibit linear movement of rod 90 (e.g. due to partial frictional interference or the like) until pivoting motion of lever 68 from the rest position seen in FIG. 9 to the engaged position seen in FIG. 10. This causes upper plate 80 to tilt (moving from the upper to the lower position of distal end 80C thereof) and bind-with and/or engage/couple-to rod 90 and move in first direction 58 seen in FIG. 10. The upper plate and rod thereby cause plunger 56 to travel in the first direction. A pivoting return motion of lever 68 from its engaged position seen in FIG. 10 to its rest position seen in FIG. 9, causes plate 80 to at least partially unbind from the rod and move back towards a non-tilted position (with distal end 80C thereof moving from its lower to its upper position) under bias of spring 88.

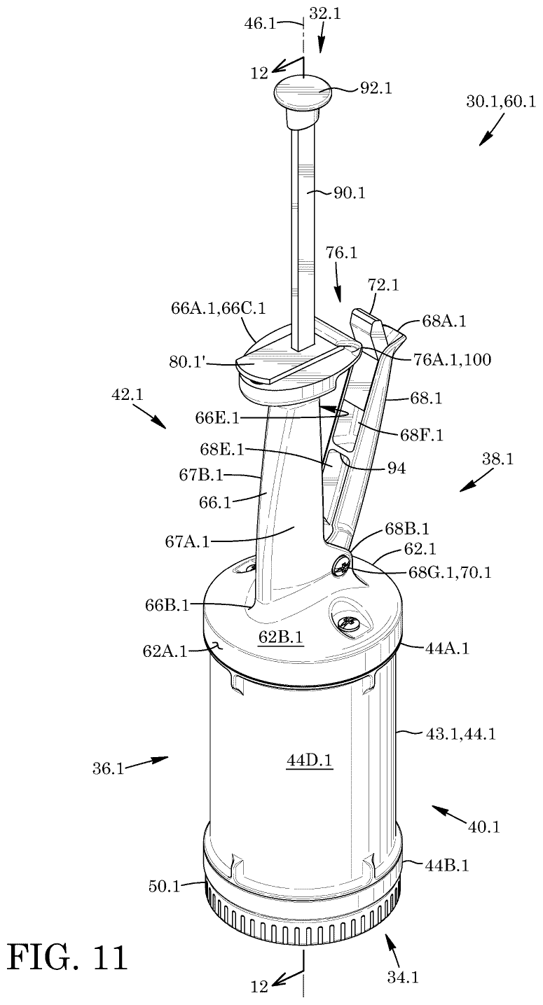

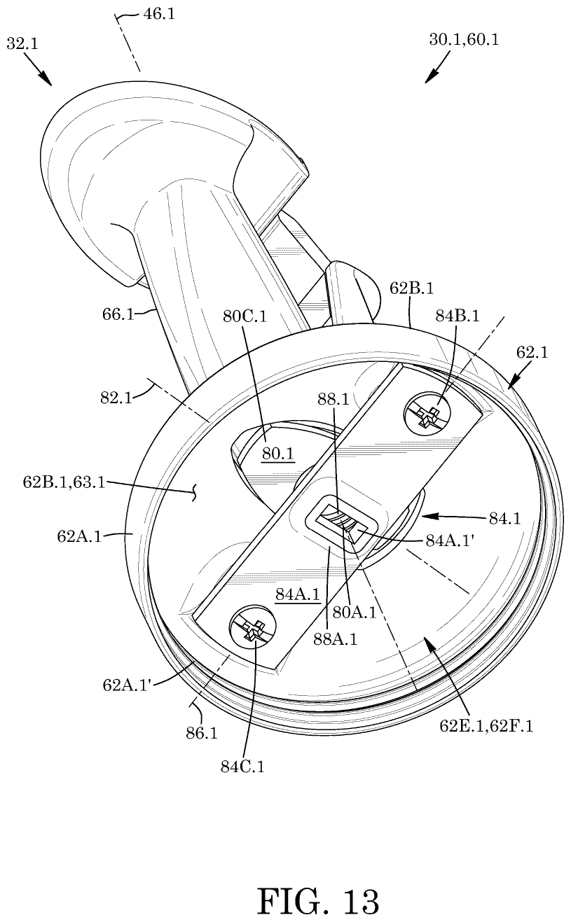

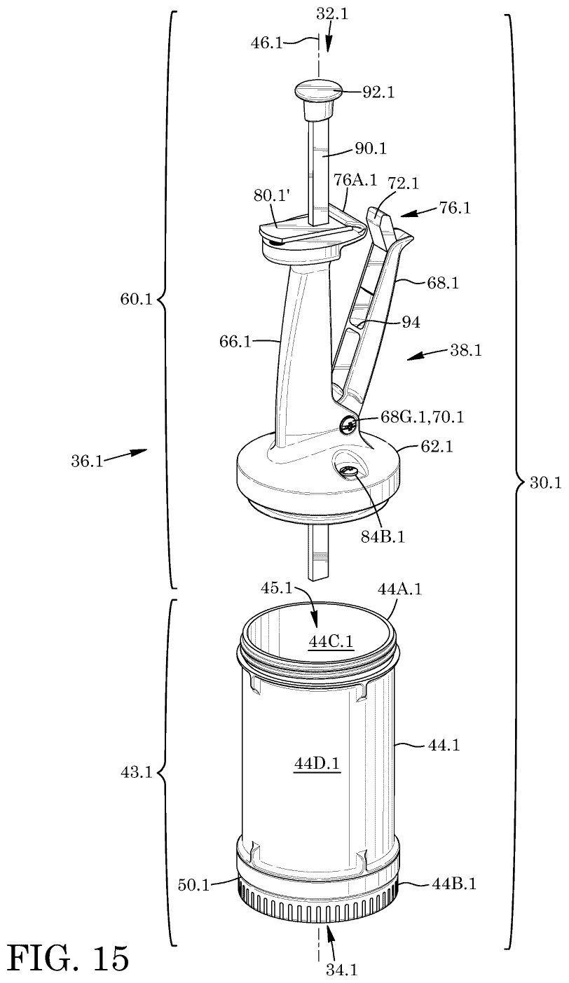

FIGS. 11 to 17 show a fluent material dispensing system 30.1 and dispensing mechanism 60.1 thereof according to another aspect. Like parts have like numbers and functions as fluent material dispensing system 30 and dispensing mechanism 60 thereof shown in FIGS. 1 to 10 with the addition of decimal extension “0.1”. Fluent material dispensing system 30.1 and dispensing mechanism 60.1 are substantially the same as fluent material dispensing system 30 and dispensing mechanism 60 shown in FIGS. 1 to 10 with at least the following exceptions.

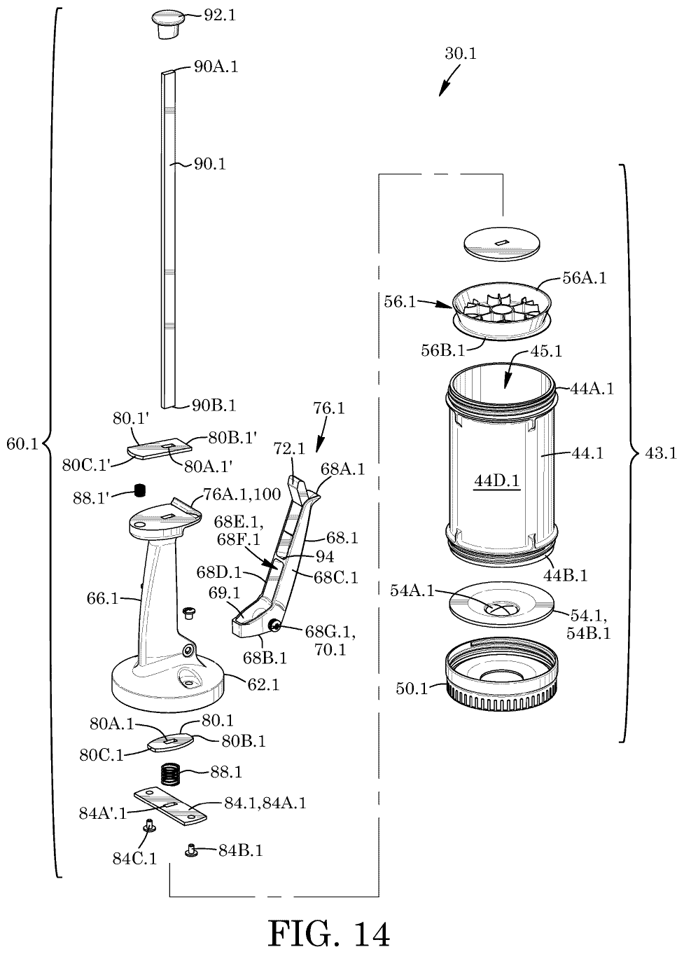

As seen in FIG. 14, elongate member 90.1 is polygonal in lateral section, in this non-limiting example being rectangular in shape. The elongate member is thus a rectangular prism in outer shape.

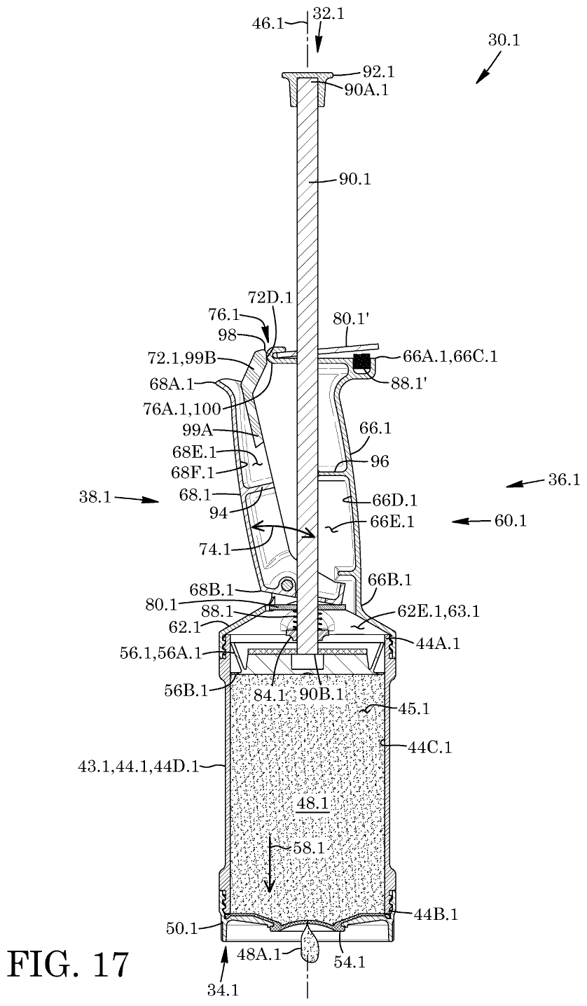

Referring to FIG. 17, lever 68.1 in this non-limiting embodiment includes a support or rib 94; however, this is not strictly required and there may be no such rib in other embodiments. The rib is positioned between top 68A.1 and bottom 68B.1 of the lever. Rib 94 is configured to promote rigidity of lever 68.1. Handle 66.1 in this non-limiting embodiment includes an elongate member support or rib 96; however, here too this is not strictly required and there may be no such rib in other embodiments. The rib is positioned between top 66A.1 and bottom 66B.1 of the handle. Rib 96 is configured to promote rigidity of handle 66.1. The rib is configured to aid in maintaining orientation of elongate member 90.1 parallel to first direction 58.1. Rib 96 may, but need not, include an aperture or recessed portion shaped to receive the elongate member therethrough. The rib is aligned with aperture 63.1 formed in dispensing cap 62. Rib 96 extends substantially perpendicular to axis 46.1 off bottle 44.1 in this non-limiting example.

Portioning mechanism 76.1 is configured to further minimize or inhibit forces applied to components of fluent material dispensing system 30.1. The following is a non-limiting embodiment which achieves this functionality.

Tooth 72.1 couples to and extends outwards and/or upwards from or adjacent top 68A.1 of lever 68.1; however, this is not strictly required and the tooth may be positioned at other locations on the lever in other embodiments. The tooth includes a tapered end portion 98 in this example. The tapered end portion is rectangular, wedge or V-shaped in lateral section. Tooth 72.1 is generally L-shaped in lateral section; however, this is not strictly required. The tooth couples to and is selectively removable from lever 68.1 according to one non-limiting embodiment. Tooth 72.1 according to another non-limiting example is integrally connected to the lever so as to form a unitary whole.

Portioning mechanism 76.1 is located on or adjacent handle 66.1 in this non-limiting embodiment. The portioning mechanism in this example is located adjacent top 66A.1 of the handle. Tooth 72.1 includes a first or lower portion 99A which couples to the handle and includes a second or upper portion 99B coupled to and angling outwards at an angle Ω relative to the lower portion thereof. Angle Ω is obtuse in this example. Each of portion 99A and 99B of tooth 72.1 is generally a rectangular prism in shape in this non-limiting example. As seen in FIG. 14, the lower portion of the tooth is shaped to fit within interior 68E.1 of lever 68.1, in this non-limiting example snugly fitting therein and therebetween so as to span sides 68C.1 and 68D.1 of the lever.

Portioning mechanism 76.1 includes one or more portion stops 76A.1 shaped to abut with tooth 72.1 when lever 68.1 is actuated. The portioning mechanism (and/or the portion stop thereof) is configured to transfer a load from lever 68.1 to a first or upper plate 80.1′ to enable translation of elongate member 90.1 when the lever is actuated. The following is a non-limiting embodiment which achieves this functionality.

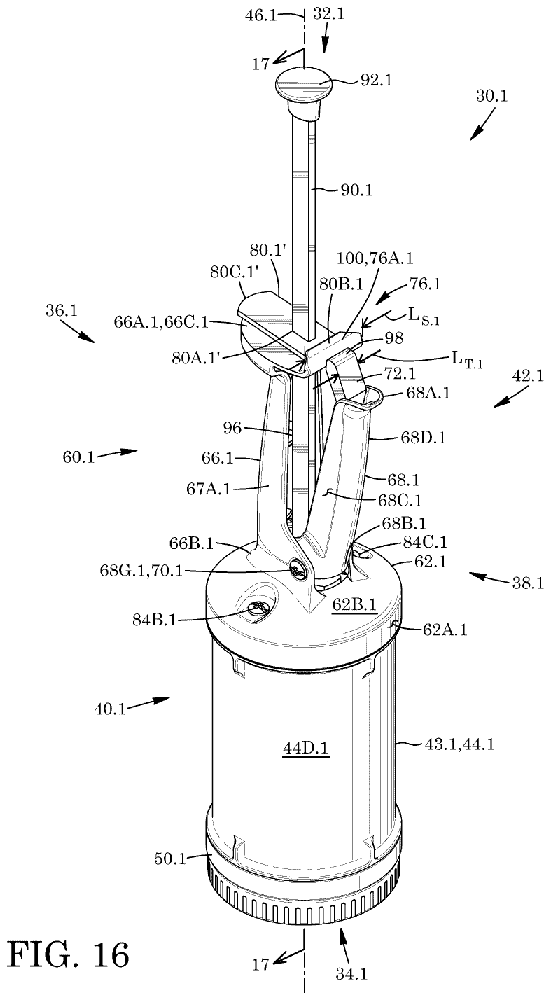

As seen in FIG. 16, portion stop 76.1 is enlarged in this non-limiting embodiment, with a length L_{S.1} in this example at least equal to and in this example larger than length L_{T.1} of the tooth. Portion stop 76A.1 has a length in this non-limiting embodiment which is greater than the distance between sides 67A.1 and 67B.1 of handle 66.1 seen in FIG. 11; however this is not strictly required. Referring back to FIG. 16, length L_{S.1} of portion stop 76A.1 generally or substantially corresponds to that of flange 66C.1 in this non-limiting example. The portioning mechanism comprises a clip 100 operatively connected to handle 66.1. The clip couples to and/or may be said to be a part of handle 66.1. Clip 100 is shaped to extend about an end 80B.1′ of plate 80.1′ to facilitate angling thereof when lever 68.1 is actuated for binding the plate with elongate member 90.1. Aperture 80A.1′ of the plate is polygonal in shape, in this non-limiting example being rectangular or square in shape. Referring to FIG. 17, tooth 72.1 is configured in this example via its tapered end portion 98 to selectively abut or operatively contact handle 66.1, which inhibits further rotation of lever 68.1. Plate 80.1′ is spring-biased and/or spring-loaded to engage the elongate member and inhibit motion of the elongate member opposite the first direction 58.1.

As seen in FIG. 14, dispensing mechanism 60.1 includes a spring-loaded second, bottom or lower plate 80.1 axially spaced-apart from upper plate 80.1′. Elongate member 90.1 is configured to extend through plate apertures 80A.1′ and 80A.1 of upper plate 80.1′ and lower plate 80.1. The lower plate is substantially similar in parts and functioning as plate 80 described for dispensing mechanism 60 shown in FIGS. 1 to 10. Lower plate 80.1 is spring-biased and/or spring-loaded to facilitate movement of elongate member 90.1 until lever 68.1 is moved to the actuated position, at which point the lever causes the lower plate to bind to the elongate member.

Referring to FIG. 17, elongate member 90.1 of fluent material dispensing system 30.1 is moveable relative to plunger 56.1 in this non-limiting example. Plate 80.1′ may be referred to and/or function as a spring-loaded locking plate to prevent or inhibit unwanted translation of elongate member 90.1. Actuation, tilting and/or depression of spring-loaded locking plate(s) 80.1 and/or 80.1′ enables selective retractive and/or downward movement of elongate member 90.1.

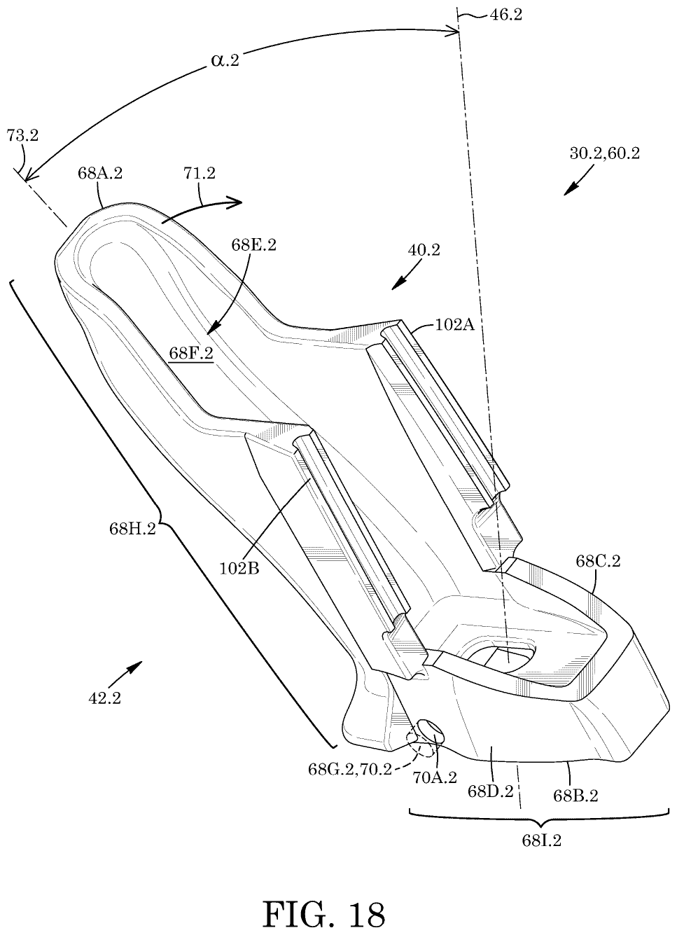

FIG. 18 shows a lever 68.2 for a dispensing mechanism 60.2 of a fluent material dispensing system 30.2 according to another aspect. Like parts have like numbers and functions as fluent material dispensing system 30.1 and dispensing mechanism 60.1 thereof shown in FIGS. 11 to 17 with the decimal extension “0.2” replacing decimal extension “0.1”. Fluent material dispensing system 30.2 and dispensing mechanism 60.2 are substantially the same as fluent material dispensing system 30.1 and dispensing mechanism 60.1 shown in FIGS. 11 to 17 with at least the following exceptions.

Lever 68.2 includes at least one portion stop having a defined shape, with the distance traveled by the lever limited by direct contact of the portion stop with a portion of the handle located within the path of travel of the lever. This thereby limits the distance traveled by the plunger to limit an expelled amount of the fluent material to a corresponding defined portion. The following is a non-limiting embodiment which achieves this functionality.

Lever 68.2 in this non-limiting embodiment include a lengthened and/or enlarged side and/or rear portion and/or at least one rib, and/or one of male or female portion(s), in this non-limiting example a pair of female portions or receptacles or channels 102A and 102B extending along left side 68C.2 and right side 68D.2 of the lever. The channels may be said to couple to and extend along respective sides of the lever. Channels 102A and 102B extend along peripheral portions of respective sides of the lever. The channels are u-shaped in lateral section in this non-limiting embodiment. Channels 102A and 102B are shaped to receive one or more portions, in non-limiting example distal peripheral portions of sides 67A and 67B of handle 66 seen in FIG. 5, for example, with the distance traveled by the lever being limited thereby. The channels are configured to mate with and align parallel the peripheral portions of the sides of the handle when lever 68.2 is in its fully actuated/engaged position.

Many additional advantages result from the structure of the present invention. It will also be appreciated that many variations are possible within the scope of the invention described herein.

Where a component (e.g. member, apparatus, assembly, device etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure and which perform the function in the illustrated exemplary embodiments of the invention.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

### ADDITIONAL DESCRIPTION

Examples of dispensing mechanisms have been described. The following clauses are offered as further description.
(1) A dispensing mechanism for a bottle or cartridge configured to hold a fluent material, the dispensing mechanism comprising: a lever actuation of which causes a plunger to slidably engage an inner sidewall of the bottle and travel in a first direction towards an outlet of the bottle to expulse the fluent material therefrom, the lever including a tooth protruding outwards a defined distance along a path of travel of the lever, with the tooth including a first end portion adjacent a first side of the lever and a second end portion adjacent a second side of the lever; and a portion stop at a defined location along the path of travel of the lever, with the distance traveled by the lever limited by direct contact of the tooth with the portion stop located within the path of travel, thereby limiting the distance traveled by the plunger to limit an expelled amount of the fluent material to a corresponding defined portion.
(2) A dispensing mechanism according to any clause herein, wherein the lever when engaged subjects the portion stop to a load and wherein the tooth is shaped to promote spreading out of said load on the portion stop so as to inhibit damage and/or wear thereto and/or deformation thereof.
(3) A dispensing mechanism for a bottle or cartridge, the dispensing mechanism comprising: a lever actuation of which causes a plunger to slidably engage an inner sidewall of the bottle and travel in a first direction towards an outlet of the bottle to expulse fluent material therefrom; and a portion stop connected to a cap and positioned at a defined location along the path of travel of the lever, with the distance traveled by the lever being limited by direct contact of a tooth of the lever with the portion stop, thereby limiting the distance traveled by the plunger to limit an expelled amount of the fluent material to a corresponding defined portion, wherein the tooth, when actuated, subjects the portion stop to a load and wherein the tooth is shaped to promote spreading out of the load so as to inhibit damage/wear to and/or deformation of the cap.
(4) A dispensing mechanism for a bottle or cartridge configured to hold a fluent material, the dispensing mechanism comprising: a lever actuation of which causes a plunger to slidably engage an inner sidewall of the bottle and travel in a first direction towards an outlet of the bottle to expulse the fluent material therefrom, the lever including a tooth protruding outwards a defined distance along a path of travel of the lever; and a portion stop at a defined location along the path of travel of the lever, with the distance traveled by the lever limited by direct contact of the tooth with the portion stop located within the path of travel, thereby limiting the distance traveled by the plunger to limit an expelled amount of the fluent material to a corresponding defined portion, wherein the lever when engaged subjects the portion stop to a load and wherein the tooth is shaped to promote spreading out of the load on the portion stop so as to inhibit damage and/or wear thereto and/or deformation thereof.
(5) A dispensing mechanism for a bottle or cartridge configured to hold a fluent material, the dispensing mechanism comprising: a lever including a tooth protruding outwards a defined distance along a path of travel of the lever, with actuation of the lever causing a plunger to slidably engage an inner sidewall of the bottle and travel in a first direction towards an outlet of the bottle to expulse the fluent material therefrom; a cap for attachment to an end of the bottle and to which the lever pivotally couples; and a portion stop operatively connected to the cap and positioned at a defined location along the path of travel of the lever, with the distance traveled by the lever limited by direct contact of the tooth with the portion stop located within the path of travel, thereby limiting the distance traveled by the plunger to limit an expelled amount of the fluent material to a corresponding defined portion, wherein the lever when actuated subjects the portion stop to a load via said tooth and wherein the tooth is shaped to promote spreading out of the load so as to inhibit damage/wear to and/or deformation of the cap.
(6) A dispensing mechanism according to any clause herein, wherein the tooth includes a first end portion adjacent a first side of the lever and a second end portion adjacent a second side of the lever.
(7) A dispensing mechanism according to any clause herein, including a portion ring to which is mounted or coupled to the portion stop, with the tooth of the lever being configured to inhibit local deformation of the portion ring or stop.
(8) A dispensing mechanism according to any clause herein, wherein the tooth selectively engages the portion stop via a loading bearing surface which is rectangular in shape.
(9) A dispensing mechanism according to any clause herein, wherein the tooth has a length which extends perpendicular to said defined distance.
(10) A dispensing mechanism according to any clause herein, wherein the tooth has a length which is larger than said defined distance.
(11) A dispensing mechanism according to any clause herein, wherein the tooth has a length which is larger than that of a respective said portion stop.
(12) A dispensing mechanism according to any clause herein, wherein the tooth selectively engages the portion stop via a loading bearing surface which is elongate.
(13) A dispensing mechanism according to any clause herein, wherein the tooth extends along a longitudinal axis and wherein each said end portion of the tooth is outwardly convex at least in part longitudinally and laterally.
(14) A dispensing mechanism according to any clause herein, wherein each said end portion of the tooth is generally or substantially quarter spherical in shape.
(15) A dispensing mechanism according to any clause herein, wherein the tooth is generally or substantially triangular in lateral section.
(16) A dispensing mechanism according to any clause herein, wherein the portion stop defines an engaged position of the lever and wherein the portion stop is replaceable with an alternate portion stop placed at an alternate defined location along the path of travel of the lever, the alternate portion stop defining an alternate engaged position different from the engaged position, thereby limiting the expelled amount of the fluent material to a different defined portion.
(17) A dispensing mechanism according to any clause herein, including a portion ring to which is mounted or coupled to the portion stop and the alternative portion stop, wherein the portion ring operatively connects to and is rotatable relative to the lever, with rotation of the portion ring enabling replacement of the portion stop with the alternate portion stop, and wherein the tooth is shaped to inhibit local deformation of the portion ring or stop.
(18) A dispensing mechanism according to any clause herein, including a portioning mechanism configured to limit the distance traveled by the lever to a defined amount, the portioning mechanism comprising said one or more portion stops.
(19) A dispensing mechanism according to any clause herein, wherein the portioning mechanism is configured to further minimize or inhibit forces applied to the dispensing cap and/or the one or more portion stops thereof
(20) A dispensing mechanism according to any clause herein, including a handle towards which the lever is actuated, with the portioning mechanism being located on or adjacent the handle.
(21) A dispensing mechanism according to any clause herein, wherein the portioning mechanism is located on or adjacent the top of the handle.
(22) A dispensing mechanism according to any clause herein, including a handle towards which the lever is actuated, with the handle including a portion stop at a defined location along the path of travel of the lever, with the distance traveled by the lever limited by direct contact of the tooth with the portion stop located within the path of travel, thereby limiting the distance traveled by the plunger to limit an expelled amount of the fluent material to a corresponding defined portion.
(23) A dispensing mechanism for a bottle or cartridge configured to hold a fluent material, the dispensing mechanism comprising: a lever actuation of which causes a plunger to slidably engage an inner sidewall of the bottle and travel in a first direction towards an outlet of the bottle to expulse the fluent material therefrom; and a handle towards which the lever is actuated, with the handle including at least one portion stop at a defined location along the path of travel of the lever, with the distance traveled by the lever limited by direct contact of the lever with the portion stop located within the path of travel, thereby limiting the distance traveled by the plunger to limit an expelled amount of the fluent material to a corresponding defined portion.
(24) A dispensing mechanism according to any clause herein, wherein said defined portion comprises up to one ounce.
(25) A dispensing mechanism according to any clause herein, wherein said defined portion comprises one to two ounces.
(26) A dispensing mechanism according to any clause herein, wherein said defined portion comprises greater than one ounce.
(27) A fluent material dispensing system according to any clause herein, including said bottle within which the fluent material is receivable and/or including said plunger.
(28) A dispensing mechanism for a bottle or cartridge configured to hold a fluent material, the dispensing mechanism comprising: a cap for attachment to an end of the bottle; a lever pivotally coupled to the cap via a metal bearing pin, with actuation of the lever causing a plunger to slidably engage an inner sidewall of the bottle and travel towards an outlet of the bottle to expulse the fluent material therefrom; and a portion stop at a defined location along the path of travel of the lever, with the distance traveled by the lever limited by contact of the lever with the portion stop located within the path of travel, thereby limiting the distance traveled by the plunger to limit an expelled amount of the fluent material to a corresponding defined portion.
(29) A dispensing mechanism according to any clause herein, wherein the metal bearing pin is made of stainless steel.
(30) A dispensing mechanism for a bottle or cartridge configured to hold a fluent material, the dispensing mechanism comprising: a cap for attachment to an end of the bottle; a lever pivotally coupled to the cap via a metal member, with actuation of the lever causing a plunger to slidably engage an inner sidewall of the bottle and travel towards an outlet of the bottle to expulse the fluent material therefrom; and a portion stop at a defined location along the path of travel of the lever, with the distance traveled by the lever limited by contact of the lever with the portion stop located within the path of travel, thereby limiting the distance traveled by the plunger to limit an expelled amount of the fluent material to a corresponding defined portion.
(31) A dispensing mechanism according to any clause herein, wherein the metal member comprises one or more of: a sex bolt; a fastener and a barrel nut shaped to threadably coupled with said fastener; a spring; a cotter pin; a clevis pin; and a set of spring loaded plungers.
(32) A dispensing mechanism according to any clause herein, wherein the sex bolt and/or the fastener and barrel nut are made of stainless steel.
(33) A dispensing mechanism for a bottle or cartridge configured to hold a fluent material, the dispensing mechanism comprising: a lever with actuation thereof causing a plunger to slidably engage an inner sidewall of the bottle and travel in a first direction towards an outlet of the bottle to expulse the fluent material therefrom; a portion stop at a defined location along the path of travel of the lever, with the distance traveled by the lever limited by contact of the lever with the portion stop located within the path of travel, thereby limiting the distance traveled by the plunger to limit an expelled amount of the fluent material to a corresponding defined portion; and a handle aligning with said first direction, the lever pivotally coupling to and being received at least in part within the handle, wherein the lever and the handle are shaped to facilitate cleaning thereof without requiring disassembling thereof.
(34) A dispensing mechanism according to any clause herein, wherein the handle has a bottom and a top and defines a continuous path between said bottom and top thereof.
(35) A dispensing mechanism according to any clause herein, wherein the handle has a bottom and a top and defines a space that is continuously open in a direction facing the lever between said bottom and top thereof.
(36) A dispensing mechanism according to any clause herein, wherein the lever has a bottom and a top and defines a continuous path between said bottom and top thereof and/or defines a space that is continuously open in a direction facing the handle between said bottom and said top thereof.
(37) A dispensing mechanism for a bottle or cartridge configured to hold a fluent material, the dispensing mechanism comprising: a lever operable between a rest position and an engaged position, which causes a plunger to slidably engage an inner sidewall of the bottle and travel in a first direction towards an outlet of the bottle to expulse the fluent material therefrom; a plate having a plate aperture, the plate movable between an upper position and a lower position; an elongate member passing through said plate aperture, the elongate member operatively coupled to the plunger and extending along the first direction, wherein pivoting motion of the lever from the rest position to the engaged position causes the plate to bind with the elongate member and move in the first direction from the upper position to the lower position, the plate and the elongate member thereby causing the plunger to travel in the first direction; and a cap for attachment to an end of the bottle opposite the outlet, the lever pivotally coupled to the cap, the cap enclosing an interior and wherein the plate is in fluid communication with said interior of the cap.
(38) A dispensing mechanism according to any clause herein, wherein the cap has an open bottom and the plate is fully and/or substantially exposed to said open bottom to facilitate cleaning thereof.
(39) A dispensing mechanism according to any clause herein, wherein the plate is made of stainless steel.
(40) A dispensing mechanism according to any clause herein, wherein the plate is made of sintered metal.
(41) A dispensing mechanism according to any clause herein, including a spring configured to bias the plate to maintain contact with the lever during motion of the lever, wherein the spring is in fluid communication with the interior of the cap to facilitate cleaning thereof.
(42) A dispensing mechanism according to any clause herein, wherein the cap has an open bottom and the spring is fully and/or substantially exposed to said open bottom to facilitate cleaning thereof.
(43) A dispensing mechanism according to any clause herein, wherein a pivoting return motion of the lever from the engaged position to the rest position causes the plate to at least partially unbind from the elongate member and move from the lower position to the upper position under bias of said spring and wherein the elongate member extends along the axis through an aperture formed in the cap, the elongate member further extending through a passageway formed within the lever.
(44) A dispensing mechanism according to any clause herein, including a handle attached to the cap, wherein the handle extends away from the bottle along an axis which is aligned with the first direction and which passes substantially through a center of the bottle.
(45) A dispensing mechanism according to any clause herein, wherein the lever when actuated extends away from the bottle generally or substantially along an axis which is aligned with the first direction and which passes substantially through a center of the bottle.
(46) A dispensing mechanism for a bottle or cartridge configured to hold a fluent material, the dispensing mechanism comprising: a lever operable between a rest position and an engaged position, which causes a plunger to slidably engage an inner sidewall of the bottle and travel in a first direction towards an outlet of the bottle to expulse the fluent material therefrom; a plate having a plate aperture, the plate movable between an upper position and a lower position; an elongate member passing through said plate aperture, the elongate member operatively coupled to the plunger and extending along the first direction, wherein pivoting motion of the lever from the rest position to the engaged position causes the plate to bind with the elongate member and move in the first direction from the upper position to the lower position, the plate and the elongate member thereby causing the plunger to travel in the first direction; and a cap for attachment to an end of the bottle opposite the outlet, the lever pivotally coupled to the cap, wherein the lever, the plate and the cap are operatively connected together in a manner which facilitates cleaning thereof.
(47) A dispensing mechanism according to any clause herein, wherein the dispensing mechanism is configured to facilitate cleaning thereof without requiring disassembling of any constituent parts thereof.
(48) A dispensing mechanism according to any clause herein, wherein the lever, the plate and the cap so operatively connected together comprise one part.
(49) A dispensing mechanism according to any clause herein, including a handle coupled to the cap and thus operatively connected to the lever and the plate as well, wherein the cap, the handle, the lever, the plate, are operatively connected together in a manner which facilitates cleaning thereof.
(50) A dispensing mechanism according to any clause herein, including a spring configured to bias the plate to maintain contact with the lever during motion of the lever, wherein the cap, the lever, the plate and the spring are operatively connected together in a manner which facilitates cleaning thereof.
(51) A dispensing mechanism according to any clause herein, including a spring configured to bias the plate to maintain contact with the lever during motion of the lever, wherein the cap, the handle, the lever, the plate and the spring are operatively connected together in a manner which facilitates cleaning thereof.
(52) A dispensing mechanism for a bottle or cartridge configured to hold a fluent material, the dispensing mechanism comprising: a lever operable between a rest position and an engaged position, which causes a plunger to slidably engage an inner sidewall of the bottle and travel in a first direction towards an outlet of the bottle to expulse the fluent material therefrom; a plate having a plate aperture, the plate movable between an upper position and a lower position; an elongate member passing through said plate aperture, the elongate member operatively coupled to the plunger and extending along the first direction, wherein pivoting motion of the lever from the rest position to the engaged position causes the plate to bind with the elongate member and move in the first direction from the upper position to the lower position, the plate and the elongate member thereby causing the plunger to travel in the first direction; and a cap for attachment to an end of the bottle opposite the outlet, the cap has inner surfaces which are generally and/or substantially exposed to facilitate cleaning thereof.
(53) A dispensing mechanism for a bottle or cartridge configured to hold a fluent material, the dispensing mechanism comprising: a lever operable between a rest position and an engaged position, which causes a plunger to slidably engage an inner sidewall of the bottle and travel in a first direction towards an outlet of the bottle to expulse the fluent material therefrom; a plate having a plate aperture, the plate movable between an upper position and a lower position; an elongate member passing through said plate aperture, the elongate member operatively coupled to the plunger and extending along the first direction, wherein pivoting motion of the lever from the rest position to the engaged position causes the plate to bind with the elongate member and move in the first direction from the upper position to the lower position, the plate and the elongate member thereby causing the plunger to travel in the first direction; and a cap for attachment to an end of the bottle opposite the outlet, the cap has a downwardly-facing inner surface which is substantially exposed to facilitate cleaning thereof.
(54) A dispensing mechanism according to any clause herein, wherein the cap has a downwardly-facing said inner surface which is substantially exposed to facilitate cleaning thereof.
(55) A dispensing mechanism according to any clause herein, wherein a sleeve portion of the cap has an inner or interior surface which is substantially exposed to facilitate cleaning thereof.
(56) A dispensing mechanism according to any clause herein, wherein a top portion of the cap has an inner or lower surface which is substantially exposed to facilitate cleaning thereof.
(57) A dispensing mechanism according to any clause herein, wherein the inner surfaces of the cap are generally or substantially exposed to facilitate cleaning thereof.
(58) A dispensing mechanism according to any clause herein, wherein the plate aperture is polygonal in shape and/or wherein the elongate member is polygonal in lateral section.
(59) A dispensing mechanism for a bottle or cartridge configured to hold a fluent material, the dispensing mechanism comprising: a lever operable between a rest position and an engaged position, which causes a plunger to slidably engage an inner sidewall of the bottle and travel in a first direction towards an outlet of the bottle to expulse the fluent material therefrom; a plate having a plate aperture that is polygonal in shape, the plate movable between an upper position and a lower position; an elongate member passing through said plate aperture, the elongate member operatively coupled to the plunger and extending along the first direction, wherein pivoting motion of the lever from the rest position to the engaged position causes the plate to bind with the elongate member and move in the first direction from the upper position to the lower position, the plate and the elongate member thereby causing the plunger to travel in the first direction, wherein the elongate member is polygonal in outer shape.
(60) A dispensing mechanism according to any clause herein, wherein the plate aperture is rectangular or square in shape.
(61) A dispensing mechanism according to any clause herein, wherein the elongate member is rectangular or square in lateral section and/or a rectangular prism in outer shape.
(62) A dispensing mechanism according to any clause herein, wherein a pivoting return motion of the lever from the engaged position to the rest position causes the plate to at least partially unbind from the elongate member and move from the lower position to the upper position under bias of said spring and wherein the elongate member extends along the axis through an aperture formed in the cap, the elongate member further extending through a passageway formed within the lever.
(63) A dispensing mechanism for a bottle or cartridge configured to hold a fluent material, the dispensing mechanism comprising: a lever operable between a rest position and an engaged position, which causes a plunger to slidably engage an inner sidewall of the bottle and travel in a first direction towards an outlet of the bottle to expulse the fluent material therefrom; a first plate having a plate aperture extending therethrough; a spring-loaded second plate spaced-apart from the first plate, the second plate having a plate aperture and being movable between an upper position and a lower position; an elongate member passing through said plate apertures, the elongate member being engageable with the plunger and extending along the first direction, wherein the first plate is configured to inhibit translation and/or linear movement of the elongate member opposite the first direction, with until pivoting motion of the lever from the rest position to the engaged position causes the second plate to bind with the elongate member and move in the first direction from the upper position to the lower position, with the second plate and the elongate member thereby causing the plunger to travel in the first direction.
(64) A dispensing mechanism according to any clause herein, wherein the first plate is spring-biased and/or spring-loaded.
(65) A dispensing mechanism according to any clause herein, wherein the first plate is spring-biased and/or spring-loaded to inhibit movement of the elongate member until the lever is moved to the actuated position.
(66) A dispensing mechanism according to any clause herein, wherein the second plate is spring-biased and/or spring-loaded to facilitate movement of the elongate member until the lever is moved to the actuated position.
(67) A dispensing mechanism for a bottle or cartridge configured to hold a fluent material, the dispensing mechanism comprising: a lever operable between a rest position and an engaged position, which causes a plunger to slidably engage an inner sidewall of the bottle and travel in a first direction towards an outlet of the bottle to expulse the fluent material therefrom; a pair of axially spaced plates; and an elongate member passing through respective apertures of the plates, wherein a first said plate is spring-biased to inhibit translation of the elongate member opposite the first direction, and wherein a second said plate is neutrally spring-biased to enable free passage of the elongate member therethrough until the lever is moved towards the engaged position so as to cause the elongate member to engage with and bias the plunger to move along the first direction.
(68) A dispensing mechanism according to any clause herein, including a handle to which the lever and the first and second plates couple and are pivotal relative thereto.
(69) A dispensing mechanism according to any clause herein, wherein the first plate extends along a longitudinal axis and wherein the second plate extends along a longitudinal axis which is angled and/or perpendicular to the longitudinal axis of the first plate.
(70) A dispensing mechanism according to any clause herein, wherein the first plate is a bottom plate.
(71) A dispensing mechanism according to any clause herein, including a cap for attachment to an end of the bottle opposite the outlet, the lever pivotally coupled to the cap and wherein the first plate couples to and is positioned within an interior of the cap.
(72) A dispensing mechanism according to any clause herein, wherein the first plate couples to the cap via a pair of spaced-apart fasteners and wherein each said fastener is enclosed by a sleeve.
(73) A dispensing mechanism according to any clause herein, wherein each said sleeve is in fluid communication with the interior of the cap.
(74) A dispensing mechanism according to any clause herein, wherein the second plate is positioned between said sleeves.
(75) A dispensing mechanism according to any clause herein, wherein the tooth is near or adjacent a bottom or lower end of the lever.
(76) A dispensing mechanism according to any clause herein, wherein the tooth couples to and extends outwards from or adjacent the top of the lever.
(77) A dispensing mechanism according to any clause herein, wherein the tooth includes a tapered end portion.
(78) A dispensing mechanism according to any clause herein, wherein the tapered end portion of the tooth is rectangular, wedge or V-shaped in lateral section.
(79) A dispensing mechanism according to any clause herein, wherein the tooth couples to and is selectively removable from the lever.
(80) A dispensing mechanism according to any clause herein, wherein the portion stop has a length equal to or greater than that of the tooth.
(81) A dispensing mechanism according to any clause herein, wherein the portion stop has a length which is greater than the distance between opposite sides of the handle.
(82) A dispensing mechanism according to any clause herein, wherein the portion stop has a length substantially equal to that of an upper flange of the handle.
(83) A dispensing mechanism according to any clause herein, wherein the portioning mechanism comprises a clip operatively connected to the handle.
(84) A dispensing mechanism according to any clause herein, wherein the clip couples to and/or is a part of the handle.
(85) A dispensing mechanism according to any clause herein, wherein the portion stop and/or clip is shaped to extend about an end of the plate to facilitate angling thereof when the lever is actuated for binding the plate with the elongate member.
(86) A dispensing mechanism according to any clause herein, wherein the portion stop comprises a lengthened and/or enlarged side and/or rear portion and/or at least one rib of the lever and/or one of a female or male portion.
(87) A dispensing mechanism for a bottle or cartridge configured to hold a fluent material, the dispensing mechanism comprising: a lever actuation of which causes a plunger to slidably engage an inner sidewall of the bottle and travel in a first direction towards an outlet of the bottle to expulse the fluent material therefrom; and a handle towards which the lever is actuated, with the lever including at least one portion stop having a defined shape, with the distance traveled by the lever limited by direct contact of the portion stop with a portion of the handle located within the path of travel of the lever, thereby limiting the distance traveled by the plunger to limit an expelled amount of the fluent material to a corresponding defined portion.
(88) A dispensing mechanism for a bottle or cartridge configured to hold a fluent material, the dispensing mechanism comprising: a cap for attachment to an end of the bottle; a lever pivotally coupled to the cap, with actuation of the lever causing a plunger to slidably engage an inner sidewall of the bottle and travel towards an outlet of the bottle to expulse the fluent material therefrom, the lever including a lengthened and/or enlarged side and/or rear portion and/or at least one rib; and a handle operatively connected to the cap and towards which the lever is actuated, with the distance traveled by the lever limited by direct contact of the lengthened and/or enlarged side and/or rear portion and/or at least one rib of the lever with a portion of the cap and/or handle located within the path of travel of the lever, thereby limiting the distance traveled by the plunger to limit an expelled amount of the fluent material to a corresponding defined portion.
(89) A dispensing mechanism according to any clause herein, wherein the plate is biased to engage the elongate member and inhibit motion of the elongate member opposite the first direction.
(90) A dispensing mechanism according to any clause herein, wherein said cap is a dispensing cap.
(91) A dispensing mechanism according to any clause herein, wherein the first plate is configured to promote and/or facilitate alignment of the elongate member relative to the plunger.
(92) A dispensing mechanism for a bottle or cartridge configured to hold a fluent material, the dispensing mechanism comprising: a cap for attachment to an end of the bottle; a lever pivotally coupled to the cap, with actuation of the lever causing a plunger to slidably engage an inner sidewall of the bottle and travel towards an outlet of the bottle to expulse the fluent material therefrom, the lever including a first of a female or male portion facing towards the handle in part; and a handle operatively connected to the cap and towards which the lever is actuated, the handle including a second of the female and male portion facing the lever at least in part, with the distance traveled by the lever limited by direct contact of the female and male portions when the lever is actuated, thereby limiting the distance traveled by the plunger to limit an expelled amount of the fluent material to a corresponding defined portion.
(93) A dispensing mechanism according to any clause herein, wherein the female portion comprises an elongate channel.
(94) A dispensing mechanism according to any clause herein, wherein the female portion comprises a pair of elongate channels.
(95) A dispensing mechanism according to any clause herein, wherein the pair of elongate channels couple to and extend along respective sides of the lever.
(96) A dispensing mechanism according to any clause herein, wherein the pair of elongate channels extend along peripheral portions of respective sides of the lever.
(97) A dispensing mechanism according to any clause herein, wherein the male portion comprises one or more peripheral portions of the sides of the handle.
(98) A fluent material dispensing system comprising the dispensing mechanism according to any clause herein.
(99) A fluent material dispensing system according to any clause herein, further including said bottle.
(100) A fluent material dispensing system according to any clause herein, further including said plunger.
(101) A fluent material dispensing system comprising: a bottle configured for holding the fluent material; a plunger configured for sliding engagement with inner sidewall of the bottle, the plunger further configured to exert a compressive force on the fluent material when traveling through the bottle interior in a first direction, thereby facilitating expulsion of the fluent material through an outlet of the bottle; and a dispensing mechanism, the dispensing mechanism comprising: i) a lever operable between a rest position and an engaged position, ii) a plate having a plate aperture, the plate movable between an upper position and a lower position, iii) an elongate member passing through said plate aperture, the elongate member operatively coupled to the plunger and extending along the first direction, wherein pivoting motion of the lever from the rest position to the engaged position causes the plate to bind with the elongate member and move in the first direction from the upper position to the lower position, the plate and the elongate member thereby causing the plunger to travel in the first direction, iv) a spring configured to bias the plate to maintain contact with the lever during motion of the lever, v) a cap for attachment to an end of the bottle opposite the outlet, and vi) a handle attached to the cap, the lever pivotally coupled to the cap, the lever and the handle extending away from the bottle along an axis which is aligned with the first direction and which passes substantially through a center of the bottle; wherein a pivoting return motion of the lever from the engaged position to the rest position causes the plate to at least partially unbind from the elongate member and move from the lower position to the upper position under bias of said spring and wherein the elongate member extends along the axis through an aperture formed in the cap, the elongate member further extending through a passageway formed within the lever.
(102) A dispensing mechanism according to any clause herein, further comprising a discharge cap configured for operative coupling to the bottle and for holding a valve seated thereon, the outlet comprising the valve, and wherein an outer surface of the bottle comprises a taper, the taper configured to inhibit one bottle from catching on the discharge cap of an adjacent bottle.
(103) A dispensing mechanism according to any clause herein, wherein the handle comprises a flange, the flange configured to rest on a user's hand so that the dispensing mechanism can be held in an ungrasped manner with the user's hand being between the flange and the bottle outlet.
(104) A fluent material dispensing system comprising: a bottle configured for holding the fluent material; a plunger configured for sliding engagement with inner sidewall of the bottle, the plunger further configured to exert a compressive force on the fluent material when traveling through the bottle interior in a first direction, thereby facilitating expulsion of the fluent material through an outlet of the bottle; and a dispensing mechanism comprising i) a lever operable between a rest position and an engaged position, the dispensing mechanism configured to cause the plunger to travel in the first direction as the lever moves from the rest position to the engaged position, wherein a distance traveled by the plunger in the first direction increases with a distance traveled by the lever from the rest position to the engaged position, and ii) a portioning mechanism configured to limit the distance traveled by the lever from the rest position to the engaged position to a defined amount, thereby limiting the distance traveled by the plunger to limit an expelled amount of the fluent material to a corresponding defined portion, wherein limiting the distance traveled by the lever comprises placing a portion stop at a defined location along a path of travel of the lever, the portion stop defining the engaged position by direct contact between the portion stop and the lever, the portion stop configured to maintain its defined location relative to motion of the dispensing mechanism, wherein the portion stop is replaceable with an alternate portion stop placed at an alternate defined location along a path of travel of the lever, the alternate portion stop defining an alternate engaged position different from the engaged position, thereby limiting the expelled amount of the fluent material to a different defined portion, and wherein the portion stop and the alternate portion stop are mounted on a portion ring, the portion ring rotatably coupled to the dispensing mechanism, and wherein replacing the portion stop with the alternate portion stop is performed by rotation of the portion ring.
(105) A dispensing mechanism according to any clause herein, wherein the lever comprises a tooth protruding a defined distance from the lever along a path travel of the lever, the distance traveled by the lever limited by direct contact of the tooth with the portion stop or the alternate portion stop located within the path of travel, and wherein the dispensing mechanism further comprises a cap for attachment to an end of the bottle, said portion stop and alternate portion stop being in a fixed position relative to the cap during operation of the lever.
(106) A dispensing mechanism according to any clause herein, wherein the lever comprises a tooth protruding a defined distance from the lever along a path of travel of the lever, the distance traveled by the lever limited by direct contact of the tooth with a portion stop located within the path of travel of the lever, said portion stop being in a fixed position relative to the cap, and wherein the lever is replaceable with an alternate lever having an alternate tooth, the alternate tooth protruding an alternate defined distance from the alternate lever along a path of travel of the alternate lever, the alternate defined distance different from the defined distance, the alternate distance traveled by the alternate lever limited by contact of the alternate tooth with the portion stop, said contact defining an alternate engaged position different from the replaced lever engaged position, thereby limiting the expelled amount of the fluent material to a different defined portion.
(107) A dispensing mechanism according to any clause herein, wherein the hand-actuated portion of the lever and the plate-contacting portion of the lever are located on opposite sides of a fulcrum of the lever.
(108) A fluent material dispensing system comprising: a bottle configured for holding the fluent material; a plunger configured for sliding engagement with inner sidewall of the bottle, the plunger further configured to exert a compressive force on the fluent material when traveling through the bottle interior in a first direction, thereby facilitating expulsion of the fluent material through an outlet of the bottle; and a dispensing mechanism comprising i) a lever operable between a rest position and an engaged position, the dispensing mechanism configured to cause the plunger to travel in the first direction as the lever moves from the rest position to the engaged position, wherein a distance traveled by the plunger in the first direction increases with a distance traveled by the lever from the rest position to the engaged position, ii) a portioning mechanism configured to limit the distance traveled by the lever from the rest position to the engaged position to a defined amount, thereby limiting the distance traveled by the plunger to limit an expelled amount of the fluent material to a corresponding defined portion, wherein limiting the distance traveled by the lever comprises placing a portion stop at a defined location along a path of travel of the lever, the portion stop defining the engaged position by direct contact between the portion stop and the lever, the portion stop configured to maintain its defined location relative to motion of the dispensing mechanism, iii) a plate having a plate aperture, the plate movable between an upper position and a lower position, iv) an elongate member passing through said aperture, the elongate member operatively coupled to the plunger and extending along the first direction, wherein pivoting motion of the lever from the rest position to the engaged position causes the plate to bind with the elongate member and move in the first direction from the upper position to the lower position, the plate and the elongate member thereby causing the plunger to travel in the first direction, and v) a spring configured to bias the plate to maintain contact with the lever during motion of the lever; wherein a pivoting return motion of the lever from the engaged position to the rest position causes the plate to at least partially unbind from the elongate member and move from the lower position to the upper position under bias of said spring, and wherein the elongate member extends through a passageway formed within the lever.
(109) A dispensing mechanism according to any clause herein, the handle further comprising an elongate member support aligned with the aperture formed in the cap, the elongate member support configured to aid in maintaining orientation of the elongate member parallel to the first direction.
(110) A dispensing mechanism according to any clause herein, wherein one or more channels are formed in a region of the inner sidewall of the bottle, said region being distal from the outlet of the bottle, the channels being free from occupation by the plunger and facilitating expulsion of air from the bottle and around the plunger as the plunger is brought into contact with the fluent material, thereby inhibiting inadvertent fluent material escape during assembly of the dispensing mechanism.
(111) A dispensing mechanism according to any clause herein, wherein the plunger is configured to frictionally engage the inner sidewall of the bottle to a degree sufficient for holding the plunger substantially in place against a force oriented opposite the first direction, the force applied by the dispensing mechanism due to the pivoting return motion of the lever or wherein a plate is biased to engage the elongate member and inhibit motion of the elongate member opposite the first direction.
(112) A dispensing mechanism according to any clause herein, wherein the plunger comprises a resilient clip configured for mating engagement with the elongate member in response to an engagement force applied to the elongate member in the first direction, said engagement force being insufficient to overcome frictional engagement of the plunger with the inner sidewall, thereby allowing engagement of the elongate member with the plunger without undesired travel of the plunger and corresponding dispense of fluent material.
(113) A dispensing mechanism according to any clause herein, wherein the plunger comprises two spaced-apart, flexible flanges configured for frictional engagement with the inner sidewall of the bottle, and wherein one of the flexible flanges extends at an angle toward the bottle sidewalls and opposite the first direction, said one of the flexible flanges thereby configured to exhibit a reduced compliance when subjected to the force oriented opposite the first direction, said reduced compliance relative to compliance of said one of the flexible flanges during travel in the first direction, said reduced compliance facilitating frictional engagement of said one of the flexible flanges with the inner sidewall for holding the plunger substantially in place against the force oriented opposite the first direction.
(114) Apparatus including any new and inventive feature, combination of features, or sub-combination of features as described herein.
(115) Methods including any new and inventive steps, acts, combination of steps and/or acts or sub-combination of steps and/or acts as described herein.

It is therefore intended that the following appended clauses and clauses hereafter introduced are interpreted to include all such modifications, permutations, additions, omissions, and sub-combinations as may reasonably be inferred. The scope of the clauses should not be limited by the preferred embodiments set forth in the examples, but should be given the broadest interpretation consistent with the description as a whole.

What is claimed is:

1. A dispensing mechanism for a bottle or cartridge configured to hold a fluent material, the dispensing mechanism comprising:
a lever actuation of which causes a plunger to slidably engage an inner sidewall of the bottle and travel in a first direction towards an outlet of the bottle to expulse the fluent material therefrom, the lever including a tooth protruding outwards a defined distance along a path of travel of the lever; and
a portion stop at a defined location along the path of travel of the lever, with the distance traveled by the lever limited by direct contact of the tooth with the portion stop located within the path of travel, thereby limiting the distance traveled by the plunger to limit an expelled amount of the fluent material to a corresponding defined portion, wherein the lever when engaged subjects the portion stop to a load and wherein the tooth is shaped to promote spreading out of said load on the portion stop so as to inhibit damage and/or wear thereto and/or deformation thereof.

2. A dispensing mechanism according to claim 1, wherein the tooth includes a first end portion adjacent a first side of the lever and a second end portion adjacent a second side of the lever.

3. A dispensing mechanism according to claim 1, wherein the tooth has a length which extends perpendicular to said defined distance, with the length of the tooth has being larger than said defined distance and/or wherein the tooth has a length which is larger than that of a respective said portion stop.

4. A dispensing mechanism according to claim 1, including a cap for attachment to an end of the bottle and to which the lever pivotally couples, and including a portion ring to which is mounted or coupled to the portion stop and an alternative portion stop, wherein the portion ring operatively connects to and is rotatable relative to the lever, with rotation of the portion ring enabling replacement of the portion stop with the alternate portion stop, and wherein the tooth is shaped to inhibit local deformation of the portion ring or stop.

5. A dispensing mechanism according to claim 1, wherein the tooth couples to and is selectively removable from the lever.

6. A dispensing mechanism according to claim 1, including a handle towards which the lever is actuated, and a portioning mechanism which limits the distance traveled by the lever to a defined amount, with the portioning mechanism comprising said one or more portion stops, and with the portioning mechanism being located on or adjacent the handle.

7. A dispensing mechanism according to claim 6, wherein the handle has a top and wherein the portioning mechanism is located on or adjacent the top of the handle.

8. A dispensing mechanism according to claim 6, wherein the portioning mechanism comprises a clip operatively connected to the handle.

9. A dispensing mechanism according to claim 1, including a cap for attachment to an end of the bottle and a metal member via which the lever pivotally couples to the cap, the metal member comprising one or more of: a sex bolt; a fastener and a barrel nut shaped to threadably coupled with said fastener; a spring; a cotter pin; a clevis pin; or a set of spring loaded plungers.

10. A dispensing mechanism for a bottle or cartridge configured to hold a fluent material, the dispensing mechanism comprising:
a lever with actuation thereof causing a plunger to slidably engage an inner sidewall of the bottle and travel in a first direction towards an outlet of the bottle to expulse the fluent material therefrom;
a portion stop at a defined location along the path of travel of the lever, with the distance traveled by the lever limited by contact of the lever with the portion stop located within the path of travel, thereby limiting the distance traveled by the plunger to limit an expelled amount of the fluent material to a corresponding defined portion; and
a handle aligning with said first direction, the lever pivotally coupling to and being received at least in part within the handle, wherein the lever and the handle are shaped to facilitate cleaning thereof without requiring disassembling thereof.

11. A dispensing mechanism according to claim 10, wherein the handle has a bottom and a top and defines a space that is continuously open in a direction facing the lever between said bottom and top thereof; and wherein the lever has a bottom and a top and defines a continuous path between said bottom and top thereof and/or defines a space that is continuously open in a direction facing the handle between said bottom and said top thereof.

12. A dispensing mechanism according to claim 10, wherein the lever includes a first of a female or male portion facing towards the handle in part and wherein the handle includes a second of the female and male portion facing the lever at least in part, with the distance traveled by the lever limited by direct contact of the female and male portions when the lever is actuated, thereby limiting the distance traveled by the plunger to limit the expelled amount of the fluent material to the corresponding defined portion.

13. A dispensing mechanism according to claim 12, wherein the female portion comprises one or more elongate channels and/or wherein the male portion comprises one or more peripheral portions of the sides of the handle.

14. A dispensing mechanism for a bottle or cartridge configured to hold a fluent material, the dispensing mechanism comprising:
a lever operable between a rest position and an engaged position, which causes a plunger to slidably engage an inner sidewall of the bottle and travel in a first direction towards an outlet of the bottle to expulse the fluent material therefrom;
a plate having a plate aperture, the plate movable between an upper position and a lower position;
an elongate member passing through said plate aperture, the elongate member operatively coupled to the plunger and extending along the first direction, wherein pivoting motion of the lever from the rest position to the engaged position causes the plate to bind with the elongate member and move in the first direction from the upper position to the lower position, the plate and the elongate member thereby causing the plunger to travel in the first direction; and
a cap for attachment to an end of the bottle opposite the outlet, the lever pivotally coupled to the cap, the cap enclosing an interior and wherein the plate is in fluid communication with said interior of the cap.

15. A dispensing mechanism according to claim 14, wherein the cap has an open bottom and wherein the plate is fully and/or substantially exposed to said open bottom to facilitate cleaning thereof.

16. A dispensing mechanism according to claim 14, including a spring configured to bias the plate to maintain contact with the lever during motion of the lever, wherein the spring is in fluid communication with the interior of the cap to facilitate cleaning thereof.

17. A dispensing mechanism according to claim 16, wherein the cap has an open bottom and the spring is fully and/or substantially exposed to said open bottom to facilitate cleaning thereof.

18. A dispensing mechanism according to claim 14, including a handle coupled to the cap, wherein the cap, the handle, the lever, the plate, are operatively connected together in a manner which facilitates cleaning thereof.

19. A dispensing mechanism according to claim 14, wherein the cap has inner surfaces which are generally and/or substantially exposed to facilitate cleaning thereof and/or wherein the cap has a downwardly-facing said inner surface which is substantially exposed to facilitate cleaning thereof.

20. A dispensing mechanism according to claim 14, wherein the plate aperture is polygonal in shape and wherein the elongate member is polygonal in outer shape.
